(19) United States
(12) Patent Application Publication
(10) Pub. No.: US 2026/0118901 A1
(43) Pub. Date: Apr. 30, 2026

(54) REFERENCE VOLTAGE OUTPUT CIRCUIT

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Masaya KONDO, Nisshin-shi (JP); Tomohiro NEZUKA, Nisshin-shi (JP); Yoshikazu FURUTA, Nisshin-shi (JP); Kunihiko NAKAMURA, Nisshin-shi (JP)

(21) Appl. No.: 19/282,442

(22) Filed: Jul. 28, 2025

(30) Foreign Application Priority Data
Oct. 30, 2024 (JP) 2024-191101

(51) Int. Cl. G05F 3/08

(52) U.S. Cl. CPC G05F 3/08

(57) ABSTRACT

A first semiconductor generates a first voltage between an input terminal and an output terminal, due to a first PN junction, by a branch current flowing between the input terminal and the output terminal. The branch current flows between an input terminal and an output terminal of a second semiconductor, thereby a second voltage due to a second PN junction is generated. A third voltage is obtained by subtracting the first voltage from a Zener voltage. A reference voltage generator outputs a sum of a voltage obtained by multiplying the third voltage by a first weight and a voltage obtained by multiplying the second voltage by a second weight, as a reference voltage.

### CROSS REFERENCE TO RELATED APPLICATION

This application is based on Japanese Patent Application No. 2024-191101 filed on Oct. 30, 2024, the disclosure of which is incorporated herein by reference.

### TECHNICAL FIELD

The present disclosure relates to a reference voltage output circuit.

### BACKGROUND

A reference voltage output circuit is disposed between a current source and a ground and outputs a reference voltage.

### SUMMARY

According to an aspect of the present disclosure, a reference voltage output circuit includes a current source disposed between a positive electrode and a negative electrode of a DC power supply, to supply a main current, which is a constant DC current, from the positive electrode to the negative electrode based on a power supply voltage between the positive electrode and the negative electrode. A Zener diode is disposed between the current source and the negative electrode, to generate a Zener voltage between the current source and the negative electrode due to Zener effect when a first branch current, which is a part of the main current, flows through the Zener diode. A first semiconductor portion has a first input terminal disposed between the current source and the negative electrode. A first output terminal is disposed between the first input terminal and the negative electrode. A first P-type semiconductor is disposed between the first input terminal and the first output terminal. A first N-type semiconductor is disposed between the first P-type semiconductor and the first output terminal and in contact with the first P-type semiconductor to form a first PN junction. A second branch current of the main current excluding the first branch current flows from the first input terminal through the first PN junction to the first output terminal, thereby generating a first voltage due to the first PN junction between the first input terminal and the first output terminal. A second semiconductor portion has a second input terminal disposed between the first semiconductor portion and the negative electrode. A second output terminal is disposed between the second input terminal and the negative electrode. A second P-type semiconductor is disposed between the second input terminal and the second output terminal. A second N-type semiconductor is disposed between the second P-type semiconductor and the second output terminal and in contact with the second P-type semiconductor to form a second PN junction. The second branch current flows from the second input terminal through the second PN junction to the second output terminal, thereby generating a second voltage due to the second PN junction between the second input terminal and the second output terminal. A reference voltage generator is disposed between the first semiconductor portion and the second semiconductor portion, to output a reference voltage. The Zener diode, the first semiconductor portion, and the second semiconductor portion are covered by a package component. The Zener voltage has temperature dependency in which the Zener voltage changes with a change in temperature of the Zener diode. The first voltage has temperature dependency in which the first voltage changes with a change in temperature of the first semiconductor portion and stress dependency in which the first voltage changes due to stress applied from the package component to the first semiconductor portion. The second voltage has temperature dependency in which the second voltage changes with a change in temperature of the second semiconductor portion and stress dependency in which the second voltage changes due to stress applied from the package component to the second semiconductor portion. A voltage dropped from the Zener voltage by the first voltage is defined as a third voltage. The reference voltage generator may output, as the reference voltage, a sum of a voltage obtained by multiplying the third voltage by a first weight and a voltage obtained by multiplying the second voltage by a second weight, so as to cancel out the temperature dependency of the Zener voltage by the temperature dependency of the first voltage and the temperature dependency of the second voltage, while canceling out the stress dependency of the first voltage and the stress dependency of the second voltage.

### BRIEF DESCRIPTION OF DRAWINGS

FIG. 1 is an electric circuit diagram showing a reference voltage output circuit according to a first embodiment, in which a current source, a Zener diode, two transistors, and a resistor divider circuit are connected.

FIG. 2 is a cross-sectional view of an integrated circuit device including an IC chip of the reference voltage output circuit of the first embodiment, for explaining temperature dependency and stress dependency of a Zener voltage, a first voltage, and a second voltage.

FIG. 3 is an electric circuit diagram showing a reference voltage output circuit in a comparative example of the first embodiment, in which a current source, a Zener diode, two diodes, and a resistor divider circuit are connected.

FIG. 4 is an electric circuit diagram showing a reference voltage output circuit according to a second embodiment, in which a current source, a Zener diode, two transistors, and a resistor divider circuit are connected.

FIG. 5 is an electric circuit diagram showing details of electric circuit configuration of the resistor divider circuit of the reference voltage output circuit in the second embodiment, in which plural resistor elements and plural switches are connected.

FIG. 6 is an electric circuit diagram showing a reference voltage output circuit according to a third embodiment, in which a current source, a Zener diode, a diode, a transistor, and a resistor divider circuit are connected.

FIG. 7 is an electric circuit diagram showing a reference voltage output circuit according to a fourth embodiment, in which a current source, a Zener diode, two diodes, a transistor, and a resistor divider circuit are connected.

FIG. 8 is an electric circuit diagram showing a reference voltage output circuit according to a fifth embodiment, in which a current source, two diodes, two Zener diodes, and a resistor divider circuit are connected.

FIG. 9 is an electric circuit diagram showing a reference voltage output circuit according to a sixth embodiment, in which a current source, two Zener diodes, two diodes, and a resistor divider circuit are connected.

FIG. 10 is an electric circuit diagram showing a reference voltage output circuit according to a seventh embodiment, in which a current source, two Zener diodes, two diodes, and a resistor divider circuit are connected.

FIG. 11 is an electric circuit diagram showing a reference voltage output circuit according to an eighth embodiment, in which a current source, one Zener diode, two transistors, and a resistor divider circuit are connected.

### DETAILED DESCRIPTION

A reference voltage output circuit is disposed between a current source and a ground, to output a reference voltage. The reference voltage output circuit includes a Zener diode and a voltage divider circuit. The Zener diode and the voltage divider circuit are arranged in parallel between the current source and the ground. The Zener diode has a cathode terminal connected to the current source and an anode terminal connected to the ground. When a first branch current, which is a part of the main current flowing from the current source, flows through the Zener diode, a Zener voltage is generated between the current source and the ground due to the Zener effect. The Zener voltage has a positive temperature dependency in which the higher the temperature of the Zener diode, the larger the Zener voltage becomes.

The voltage divider circuit includes a first resistor element, a second resistor element, a first diode, and a second diode connected in series between the current source and the ground. Hereinafter, the first diode and the second diode may be collectively referred to as diodes, and the first resistor element and the second resistor element may be collectively referred to as resistor elements. The diodes are connected in series between the resistor elements and the ground. The first diode has an anode terminal connected to the resistor elements, and a cathode terminal connected to the second diode. The second diode has an anode terminal connected to the first diode and a cathode terminal connected to the ground. Each of the diodes has a P-type semiconductor and an N-type semiconductor disposed on the ground side of the P-type semiconductor and joined to the P-type semiconductor to form a PN junction. The second branch current, which is the remaining current excluding the first branch current from the main current, flows to the ground through the resistor elements and the diodes.

A first inter-terminal voltage between the anode terminal and the cathode terminal of the first diode is caused by the PN junction, and has a negative temperature dependency in which the higher the temperature of the first diode, the smaller the first inter-terminal voltage becomes. A second inter-terminal voltage between the anode terminal and the cathode terminal of the second diode is caused by the PN junction, and has a negative temperature dependency in which the higher the temperature of the second diode, the smaller the second inter-terminal voltage becomes. The voltage divider circuit outputs, as a reference voltage, a sum of a voltage obtained by multiplying the Zener voltage by a first weight, a voltage obtained by multiplying the first inter-terminal voltage by a second weight, and a voltage obtained by multiplying the second inter-terminal voltage by a third weight. The first weight, the second weight, and the third weight are set by voltage division by the resistor elements. As a result, the temperature dependency of the Zener voltage is offset by the temperature dependency of the first inter-terminal voltage and the temperature dependency of the second inter-terminal voltage. Therefore, the reference voltage output from the voltage divider circuit is restricted from changing due to the temperature change of the Zener diode.

In the reference voltage output circuit, the temperature dependency of the Zener voltage is offset by the temperature dependency of the first inter-terminal voltage and the temperature dependency of the second inter-terminal voltage. Therefore, it is possible to suppress the change in the reference voltage caused by the temperature change of the Zener diode. However, when the Zener diode, the first diode, and the second diode form an integrated circuit device, the Zener diode, the first diode, and the second diode are covered by a package component. For example, due to thermal expansion of the package component, stress may be applied from the package component to the Zener diode and the diodes.

The Zener voltage has a positive stress dependency. When a tensile stress is applied to the Zener diode from the package component, the Zener voltage increases. When a compressive stress is applied to the Zener diode from the package component, the Zener voltage decreases. Similarly, the first inter-terminal voltage has a positive stress dependency. When a tensile stress is applied to the first diode from the package component, the first inter-terminal voltage increases. When a compressive stress is applied to the first diode from the package component, the first inter-terminal voltage decreases. The second inter-terminal voltage has a positive stress dependency. When a tensile stress is applied to the second diode from the package component, the second inter-terminal voltage increases. When a compressive stress is applied to the second diode from the package component, the second inter-terminal voltage decreases. Therefore, the reference voltage output from the voltage divider circuit changes due to the stress applied to the Zener diode from the package component.

The present disclosure provides a reference voltage output circuit to suppress changes in the reference voltage caused by changes in temperature while suppressing changes in the reference voltage caused by changes in stress.

According to one aspect of the present disclosure, a reference voltage output circuit includes a current source disposed between a positive electrode and a negative electrode of a DC power supply, to supply a main current, which is a constant DC current, from the positive electrode to the negative electrode based on a power supply voltage between the positive electrode and the negative electrode. A Zener diode is disposed between the current source and the negative electrode, to generate a Zener voltage between the current source and the negative electrode due to the Zener effect when a first branch current, which is a part of the main current, flows through the Zener diode. A first input terminal is disposed between the current source and the negative electrode. A first output terminal is disposed between the first input terminal and the negative electrode. A first P-type semiconductor is disposed between the first input terminal and the first output terminal. A first N-type semiconductor is provided between the first P-type semiconductor and the first output terminal and in contact with the first P-type semiconductor to form a first PN junction. A second branch current of the main current excluding the first branch current flows from the first input terminal through the first PN junction to the first output terminal, thereby generating a first voltage due to the first PN junction between the first input terminal and the first output terminal. A second input terminal is disposed between the first semiconductor portion and the negative electrode. A second output terminal is disposed between the second input terminal and the negative electrode. A second P-type semiconductor is disposed between the second input terminal and the second output terminal. A second N-type semiconductor is provided between the second P-type semiconductor and the second output terminal and in contact with the second P-type semiconductor to form a second PN junction. A second branch current flows from the second input terminal through the second PN junction to the second output terminal, thereby generating a second voltage caused by the second PN junction between the second input terminal and the second output terminal. A reference voltage generator is provided between the first semiconductor portion and the second semiconductor portion, to output a reference voltage. The Zener diode, the first semiconductor portion, and the second semiconductor portion are covered by a package component. The Zener voltage has temperature dependency in which the Zener voltage changes with a change in temperature of the Zener diode. The first voltage has temperature dependency in which the first voltage changes with a change in temperature of the first semiconductor portion and stress dependency in which the first voltage changes due to stress applied from the package component to the first semiconductor portion. The second voltage has temperature dependency in which the second voltage changes with a change in temperature of the second semiconductor portion and stress dependency in which the second voltage changes due to stress applied from the package component to the second semiconductor portion. A voltage dropped from the Zener voltage by the first voltage is defined as a third voltage. The reference voltage generator outputs, as the reference voltage, a sum of a voltage obtained by multiplying the third voltage by a first weight and a voltage obtained by multiplying the second voltage by a second weight, so as to cancel out the temperature dependency of the Zener voltage by the temperature dependency of the first voltage and the temperature dependency of the second voltage, while canceling out the stress dependency of the first voltage and the stress dependency of the second voltage.

Therefore, it is possible to provide a reference voltage output circuit to suppress changes in the reference voltage caused by changes in temperature and suppress changes in the reference voltage caused by changes in stress.

According to another aspect of the present disclosure, a reference voltage output circuit includes a current source disposed between a positive electrode and a negative electrode of a DC power supply, to supply a main current, which is a constant DC current, from the positive electrode to the negative electrode based on a power supply voltage between the positive electrode and the negative electrode. A Zener diode is disposed between the current source and the negative electrode, to generate a Zener voltage between the current source and the negative electrode due to the Zener effect when a first branch current, which is a part of the main current, flows through the Zener diode. A first input terminal is disposed between the current source and the negative electrode. A first output terminal is disposed between the first input terminal and the negative electrode. A first P-type semiconductor is disposed between the first input terminal and the first output terminal. A first N-type semiconductor is provided between the first P-type semiconductor and the first output terminal and in contact with the first P-type semiconductor to form a first PN junction. A second branch current of the main current excluding the first branch current flows from the first input terminal through the first PN junction to the first output terminal, thereby generating a first voltage due to the first PN junction between the first input terminal and the first output terminal. A second input terminal is disposed between the first semiconductor portion and the negative electrode. A second output terminal is disposed between the second input terminal and the negative electrode. A second P-type semiconductor is disposed between the second input terminal and the second output terminal. A second N-type semiconductor is provided between the second P-type semiconductor and the second output terminal and in contact with the second P-type semiconductor to form a second PN junction. A second branch current flows from the second input terminal through the second PN junction to the second output terminal, thereby generating a second voltage caused by the second PN junction between the second input terminal and the second output terminal. A reference voltage generator is provided between the first semiconductor portion and the second semiconductor portion, to output a reference voltage. The Zener diode, the first semiconductor portion, and the second semiconductor portion are covered by a package component. The Zener voltage has temperature dependency in which the Zener voltage changes with a temperature change of the Zener diode, and a stress dependency in which the Zener voltage changes due to stress applied to the Zener diode from the package component. The first voltage has temperature dependency in which the first voltage changes with a temperature change of the first semiconductor portion, and a stress dependency in which the first voltage changes due to stress applied to the first semiconductor portion from the package component. The second voltage has temperature dependency in which the second voltage changes with a temperature change of the second semiconductor portion, and a stress dependency in which the second voltage changes due to stress applied to the second semiconductor portion from the package component. A voltage dropped from the Zener voltage by the first voltage is defined as a third voltage. The reference voltage generator outputs, as the reference voltage, a sum of a voltage obtained by multiplying the third voltage by a first weight and a voltage obtained by multiplying the second voltage by a second weight, so as to cancel out the temperature dependency of the Zener voltage by the temperature dependency of the first voltage and the temperature dependency of the second voltage, cancel out the stress dependency of the first voltage and the stress dependency of the second voltage, and cancel out the stress dependency of the Zener voltage by the stress dependency of the first voltage.

Therefore, it is possible to provide a reference voltage output circuit to suppress changes in the reference voltage caused by changes in temperature and to suppress changes in the reference voltage caused by changes in stress.

Hereinafter, embodiments of the present disclosure will be described with reference to the drawings. In the following embodiments, parts that are the same or equivalent to each other are denoted by the same reference numerals in the drawings to simplify the explanation.

### First Embodiment

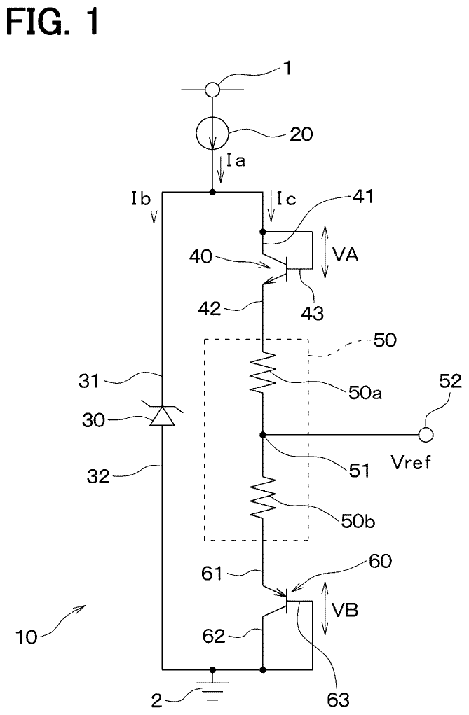

As shown in FIG. 1, a reference voltage output circuit 10 includes a current source 20, a Zener diode 30, a transistor 40, a resistor divider circuit 50, and a transistor 60. The current source 20 is disposed between the positive electrode 1 and the negative electrode 2 of the DC power supply. The current source 20 is a constant current power source that provides a main current Ia, which is a constant DC current, from the positive electrode 1 to the negative electrode 2 based on a power supply voltage (i.e., DC voltage) between the positive electrode 1 and the negative electrode 2.

In this embodiment, the Zener diode 30 is disposed between the current source 20 and the negative electrode 2. The transistor 40, 60 and the resistor divider circuit 50 are disposed between the current source 20 and the negative electrode 2. Therefore, the transistor 40, 60, and the resistor divider circuit 50 are arranged in parallel with the Zener diode 30, between the current source 20 and the negative electrode 2. A branch current Ib flows through the Zener diode 30 as a first branch current. The branch current Ib is a part of the main current Ia. A branch current Ic flows through the transistor 40, 60 and the resistor divider circuit 50 as a second branch current. The branch current Ic is the remaining current of the main current Ia other than the branch current Ib.

The Zener diode 30 has a cathode terminal 31 connected to the current source 20 and an anode terminal 32 connected to the negative electrode 2. When the branch current Ib flows from the current source 20, the Zener diode 30 generates a Zener voltage between the cathode terminal 31 and the anode terminal 32 due to the Zener effect. That is, the Zener diode 30 generates a Zener voltage between the current source 20 and the negative electrode 2 due to the Zener effect.

The transistor 40 has a collector terminal 41 serving as a first input terminal connected to the current source 20, and an emitter terminal 42 serving as a first output terminal connected to the resistor divider circuit 50. The transistor 40 is a first semiconductor portion having a base terminal 43 connected to the collector terminal 41. This causes the transistor 40 to be diode-connected. In this embodiment, the transistor 40 is a bipolar junction transistor (BJT). The transistor 40 is an NPN type transistor. The transistor 40 includes an N-type semiconductor arranged between the current source 20 and the resistor divider circuit 50, a P-type semiconductor arranged between the N-type semiconductor and the resistor divider circuit 50, and an N-type semiconductor arranged between the P-type semiconductor and the resistor divider circuit 50.

For the sake of convenience, the two N-type semiconductors of the transistor 40 will be described as follows in order to distinguish them from one another. The N-type semiconductor disposed between the current source 20 and the P-type semiconductor is defined as a positive-side N-type semiconductor, and the N-type semiconductor disposed between the P-type semiconductor and the resistor divider circuit 50 is defined as a negative-side N-type semiconductor. The collector terminal 41 is connected to the positive-side N-type semiconductor. The base terminal 43 is connected to the P-type semiconductor. The P-type semiconductor is a first P-type semiconductor in contact with the negative-side N-type semiconductor to form a first PN junction. The negative-side N-type semiconductor is a first N-type semiconductor to which the emitter terminal 42 is connected. Hereinafter, the transistor 40 and the transistor 60 will be collectively referred to as the transistors 40, 60.

The resistor divider circuit 50 in FIG. 1 is a reference voltage generator disposed between the transistor 40 and the transistor 60. The resistor divider circuit 50 includes a resistor element 50a and a resistor element 50b. The resistor element 50a and the resistor element 50b are collectively referred to as resistor elements 50a, 50b. The resistor element 50a and the resistor element 50b are connected in series between the transistor 40 and the transistor 60. Furthermore, the resistor element 50a is disposed adjacent to the transistor 40 with respect to the resistor element 50b. The resistor elements 50a, 50b constitute a common connection terminal 51 that is commonly connected to each other. In this embodiment, the common connection terminal 51 is connected to the output port 52. The output port 52 outputs a reference voltage Vref, as will be described later.

The transistor 60 is disposed between the resistor divider circuit 50 and the negative electrode 2. The transistor 60 has an emitter terminal 61 serving as a second input terminal connected to the resistor divider circuit 50, and a collector terminal 62 serving as a second output terminal connected to the negative electrode 2. The transistor 60 is a second semiconductor portion having a base terminal 63 connected to the collector terminal 62. This results in the transistor 60 being diode-connected. In this embodiment, like the transistor 40, a BJT is used as the transistor 60.

The transistor 60 is a PNP type transistor. The transistor 60 includes a P-type semiconductor arranged between the resistor divider circuit 50 and the negative electrode 2, an N-type semiconductor arranged between the P-type semiconductor and the negative electrode 2, and a P-type semiconductor arranged between the N-type semiconductor and the negative electrode 2. For the sake of convenience, the two P-type semiconductors of the transistor 60 will be described below in order to distinguish them from each other. That is, the P-type semiconductor arranged between the resistor divider circuit 50 and the N-type semiconductor is the positive-side P-type semiconductor, and the P-type semiconductor arranged between the N-type semiconductor and the negative electrode 2 is the negative-side P-type semiconductor. The emitter terminal 61 is connected to the positive-side P-type semiconductor. The positive-side P-type semiconductor is a second P-type semiconductor in contact with the N-type semiconductor to form a second PN junction. The N-type semiconductor is a second N-type semiconductor to which the base terminal 63 is connected. The collector terminal 62 is connected to the negative-side P-type semiconductor.

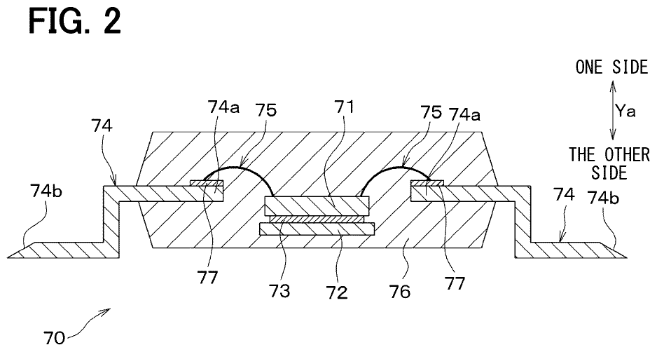

The current source 20, the Zener diode 30, the transistor 40, 60, and the resistor divider circuit 50 of this embodiment constitute an IC chip 71 shown in FIG. 2. That is, the IC chip 71 includes the current source 20, the Zener diode 30, the transistor 40, 60, and the resistor divider circuit 50. FIG. 2 is a cross-sectional view of an integrated circuit device 70 including the IC chip 71 of this embodiment. The IC chip 71, a base 72, an adhesive layer 73, plural lead frames 74, plural bonding wires 75, and a resin part 76 constitute the integrated circuit device 70. The IC chip 71 is disposed on one surface of the base 72 in the thickness direction Ya.

The IC chip 71 is fixed to one side of the base 72 in the thickness direction Ya by the adhesive layer 73. The lead frames 74 electrically connect the IC chip 71 to a circuit board outside the integrated circuit device 70. The bonding wire 75 electrically connects one end 74a of the lead frame 74 to the IC chip 71. The bonding wire 75 is connected to the lead frame 74 via the pad 77. The one end 74a of the lead frame 74 is disposed inside the resin part 76.

The other end 74b of the lead frame 74 is disposed outside the resin part 76. The IC chip 71, the base 72, the adhesive layer 73, the lead frames 74, and the bonding wires 75 are covered by the resin part 76 from the one side and the other side in the thickness direction Ya. The resin part 76 is a member made of an electrically insulating resin material. The integrated circuit device 70 of this embodiment is used, for example, as an electronic component for use in a vehicle. The resin part 76 constitutes a package part with the base 72 so as to cover the IC chip 71. Next, the operation of the reference voltage output circuit 10 of this embodiment will be described with reference to FIGS. 1, 2 and 3.

The current source 20 causes the main current Ia to flow from the positive electrode 1 to the negative electrode 2 based on the power supply voltage between the positive electrode 1 and the negative electrode 2. The branch current Ib, which is a part of the main current Ia, flows from the current source 20 through the Zener diode 30 to the negative electrode 2. Accordingly, the Zener diode 30 generates a Zener voltage VZ between the current source 20 and the negative electrode 2 due to the Zener effect. On the other hand, the branch current Ic other than the branch current Ib of the main current Ia flows from the current source 20 to the negative electrode 2 through the transistors 40, 60 and the resistor elements 50a, 50b.

A part of the branch current Ic flows as a base current from the base terminal 43 of the transistor 40 through the first PN junction to the emitter terminal 42. This causes the transistor 40 to turn on. Accordingly, in the transistor 40, the remaining current other than the base current of the branch current Ic flows from the collector terminal 41 to the emitter terminal 42 through the first PN junction. Therefore, the branch current Ic flows from the collector terminal 41 through the first PN junction to the emitter terminal 42. Thus, a voltage VA due to the first PN junction is generated between the collector terminal (i.e., the first input terminal) 41 and the emitter terminal 42 (i.e., the second output terminal).

Further, the branch current Ic flows from the emitter terminal 61 of the transistor 60 through the second PN junction to the N-type semiconductor. Of the branch current Ic, the base current flows out from the N-type semiconductor to the base terminal 63. The base current bypasses the negative-side P-type semiconductor and flows to the collector terminal 62. This causes the transistor 60 to turn on. Therefore, the remaining current of the branch current Ic other than the base current flows from the N-type semiconductor through the negative-side P-type semiconductor and the collector terminal 62 to the negative electrode 2.

Therefore, the branch current Ic flows from the emitter terminal 61 through the second P-type semiconductor and the collector terminal 62 to the negative electrode 2. Thus, a voltage VB, which is a second voltage caused by the second PN junction, is generated between the emitter terminal 61 and the collector terminal 62. Furthermore, as shown in Formula 1, the resistor divider circuit 50 outputs a reference voltage Vref from the common connection terminal 51a. The reference voltage Vref is a sum of a voltage obtained by multiplying a voltage (VZ−VA) by a first weight and a voltage obtained by multiplying a voltage VB by a second weight. The voltage (VZ−VA) is obtained by stepping down from the Zener voltage VZ by the voltage VA.

$$V ref = \frac{R 2}{R 1 + R 2} ( V Z - VA ) + \frac{R 1}{R 1 + R 2} V B \qquad Formula 1$$

The resistance value of the resistor element 50a is R1, and the resistance value of the resistor element 50b is R2. In Formula 1, the first weight is a division value obtained by dividing R2 by the sum (R1+R2) of R1 and R2. The second weight is division value obtained by dividing R1 by the sum (R1+R2) of R1 and R2. Therefore, the reference voltage Vref is a sum of a divided voltage obtained by dividing the voltage (VZ−VA) by the resistor elements 50a, 50b and a divided voltage obtained by dividing the voltage VB by the resistor elements 50a, 50b.

For example, when the integrated circuit device 70 is mounted in an automobile, the ambient temperature of the integrated circuit device 70 may rise, and heat may be transferred from the periphery of the integrated circuit device 70 through the resin part 76 to the IC chip 71. In this case, each temperature of the resin part 76 and the IC chip 71 rises. The Zener voltage VZ has temperature dependency, specifically, a positive temperature dependency in which the Zener voltage VZ increases as the temperature of the Zener diode 30 increases, while the Zener voltage VZ decreases as the temperature of the Zener diode 30 decreases. The voltage VA has temperature dependency which is negative, that is, the voltage VA decreases as the temperature of the transistor 40 increases, whereas the voltage VA increases as the temperature of the transistor 40 decreases.

Therefore, the voltage VZ-VA has a positive temperature dependency. When the temperature of the Zener diode 30 and the temperature of the transistor 60 each rise, the voltage VZ-VA increases. When the temperature of the Zener diode 30 and the temperature of the transistor 60 each decrease, the voltage VZ-VA decreases. Furthermore, the voltage VB has temperature dependency which is negative, that is, the voltage VB decreases as the temperature of the transistor 60 increases, whereas the voltage VB increases as the temperature of the transistor 60 decreases.

For example, in the packaging process of the integrated circuit device 70, when the IC chip 71 is fixed to the base 72 by an adhesive, the adhesive hardens and shrinks. At this time, stress is applied to the IC chip 71 from the adhesive. For example, after the die bonding process, when the periphery of the IC chip 71 is covered with a resin material to form the resin part 76, the resin material hardens and shrinks. At this time, stress is applied from the resin part 76 to the IC chip 71.

Furthermore, the resin material expands or contracts due to heat or humidity, which causes stress to be applied from the resin part 76 to the IC chip 71. For example, when the packaged integrated circuit device 70 is soldered onto a circuit board, the molten solder hardens and shrinks, causing stress in the solder. This stress is applied to the IC chip 71 through the lead frame 74 and the resin part 76. Such stress caused by temperature changes, humidity, soldering, and the like is applied to the IC chip 71 from the resin part 76, that is, the package part.

Therefore, in this embodiment, stress is applied from the resin part 76 to the Zener diode 30 and the transistor 40, 60. The Zener voltage VZ has a stress dependency due to the piezoelectric junction effect. The stress dependency is positive, that is, when a tensile stress is applied to the Zener diode 30, the Zener voltage VZ increases, and when a compressive stress is applied to the Zener diode 30, the Zener voltage VZ decreases.

The voltage VA has a stress dependency due to the piezo junction effect. The stress dependency is positive, that is, when a tensile stress is applied to the transistor 40, the voltage VA increases, whereas when a compressive stress is applied to the transistor 40, the voltage VA decreases. The voltage VB has a positive stress dependency due to the piezo junction effect. The stress dependency is positive, that is, when a tensile stress is applied to the transistor 60, the voltage VB increases, whereas when a compressive stress is applied to the transistor 60, the voltage VB decreases.

The stress exerted on the Zener diode 30 and the transistor 40, 60 by the resin part 76 is represented as σ. Furthermore, a value obtained by partially differentiating the reference voltage Vref with respect to the stress is set as a stress coefficient of the reference voltage Vref. A value obtained by partially differentiating the Zener voltage VZ with respect to the stress is defined as a stress coefficient of the Zener voltage VZ. The stress coefficient of the Zener voltage VZ is a value obtained by dividing ∂VZ by ∂σ. A value obtained by partially differentiating the voltage VA with respect to the stress is defined as a stress coefficient of the voltage VA. A value obtained by partially differentiating the voltage VB with respect to the stress is defined as a stress coefficient of the voltage VB.

The stress coefficient of the reference voltage Vref can be expressed by the stress coefficient of the Zener voltage VZ, the stress coefficient of the voltage VA, and the stress coefficient of the voltage VB, as shown in Formula 2.

$$\frac{\partial }{\partial σ} V ref = \frac{R 2}{R 1 + R 2} ( \frac{\partial }{\partial σ} V Z - \frac{\partial }{\partial σ} VA ) + \frac{R 1}{R 1 + R 2} \frac{\partial }{\partial σ} V B ≅ 0 \qquad Formula 2$$

In this embodiment, the transistor 40, 60 and the Zener diode 30 are set so that the stress coefficient of the voltage VA is greater than the stress coefficient of the voltage VB, and that the stress coefficient of the voltage VA is greater than the stress coefficient of the Zener voltage VZ. A tensile stress is represented by a positive value, and a compressive stress is represented by a negative value. A value obtained by subtracting the stress coefficient of the voltage VA from the stress coefficient of the Zener voltage VZ is a negative value. The stress coefficient of the voltage VB is a positive value. Therefore, the stress coefficient of the reference voltage Vref can be made close to zero, as shown in Formula 2.

In this embodiment, the resistor divider circuit 50 outputs the reference voltage Vref, which is the sum of the voltage obtained by multiplying the voltage (VZ−VA) by the first weight and the voltage obtained by multiplying the voltage VB by the second weight. As a result, the temperature dependency of the Zener voltage VZ is offset by the temperature dependency of the voltage VA and the temperature dependency of the voltage VB. In addition, the stress dependency of voltage VA and the stress dependency of voltage VB cancel each other out. Furthermore, the stress dependency of the Zener voltage VZ is offset by the stress dependency of the voltage VA.

According to the present embodiment, the reference voltage output circuit 10 includes the current source 20, the Zener diode 30, the transistor 40, 60, and the resistor divider circuit 50. The current source 20 is disposed between the positive electrode 1 and the negative electrode 2 of a DC power supply, and causes a main current Ia to flow from the positive electrode 1 to the negative electrode 2 based on the power supply voltage between the positive electrode 1 and the negative electrode 2. The Zener diode 30 is disposed between the current source 20 and the negative electrode 2, and has the cathode terminal 31 connected to the current source 20 and the anode terminal 32 connected to the negative electrode 2.

In the Zener diode 30, a branch current Ib, which is a part of the main current Ia, flows between the cathode terminal 31 and the anode terminal 32, and thereby a Zener voltage due to the Zener effect is generated between the current source 20 and the negative electrode 2. The transistor 40 has the collector terminal 41 connected to the current source 20, and the emitter terminal 42 connected to the negative electrode 2. The transistor 40 has a first P-type semiconductor arranged between the collector terminal 41 and the emitter terminal 42, and a first N-type semiconductor provided between the first P-type semiconductor and the emitter terminal 42 and in contact with the first P-type semiconductor to form a first PN junction.

A branch current Ic, which is a part of the main current Ia except for the branch current Ib, flows between the collector terminal 41 and the emitter terminal 42 through the first PN junction of the transistor 40. As a result, a voltage VA due to the first PN junction is generated between the collector terminal 41 and the emitter terminal 42. The transistor 60 is disposed between the resistor divider circuit 50 and the negative electrode 2. The transistor 60 has the emitter terminal 61 connected to the resistor divider circuit 50 and the collector terminal 62 connected to the negative electrode 2.

The transistor 60 has a second P-type semiconductor arranged between the emitter terminal 61 and the collector terminal 62, and a second N-type semiconductor provided between the second P-type semiconductor and the collector terminal 62 and in contact with the second P-type semiconductor to form a second PN junction. A branch current Ic flows through the second PN junction of the transistor 60 between the emitter terminal 61 and the collector terminal 62. As a result, a voltage VB due to the second PN junction is generated between the emitter terminal 61 and the collector terminal 62. The resistor divider circuit 50 is provided between the transistor 40 and the transistor 60 and outputs the reference voltage Vref from the output port 52. The Zener diode 30 and the transistor 40, 60 are covered with the resin part 76.

The Zener voltage VZ has temperature dependency such that the Zener voltage VZ increases as the temperature of the Zener diode 30 increases. The Zener voltage VZ has stress dependency such that when a tensile stress is applied from the resin part 76 to the Zener diode 30, the Zener voltage VZ increases, and when a compressive stress is applied from the resin part 76 to the Zener diode 30, the Zener voltage VZ decreases. The voltage VA has temperature dependency such that the voltage VA decreases as the temperature of the transistor 40 increases. The voltage VA has a stress dependency such that the voltage VA increases when a tensile stress is applied to the transistor 40 from the resin part 76, and the voltage VA decreases when a compressive stress is applied to the transistor 40 from the resin part 76. The voltage VB has temperature dependency such that the voltage VB decreases as the temperature of the transistor 60 increases. The voltage VB has a stress dependency such that when a tensile stress is applied to the transistor 60 from the resin part 76, the voltage VB increases, and when a compressive stress is applied to the transistor 60 from the resin part 76, the voltage VB decreases.

A voltage dropped from the Zener voltage VZ by a voltage VA (that is, a first voltage) is defined as a voltage (VZ−VA), and the voltage (VZ−VA) is equivalent to the third voltage. The resistor divider circuit 50 outputs, as the reference voltage Vref, a sum of a voltage obtained by multiplying the voltage (VZ−VA) by the first weight and a voltage obtained by multiplying the voltage VB by the second weight. As a result, the temperature dependency of the Zener voltage VZ is offset by the temperature dependency of the voltage VA and the temperature dependency of the voltage VB. In addition, the stress dependency of the voltage VA and the stress dependency of the voltage VB are offset. Furthermore, the stress dependency of the Zener voltage VZ is offset by the stress dependency of the voltage VA. As a result, it is possible to provide the reference voltage output circuit 10 to suppresses changes in the reference voltage Vref caused by temperature changes while suppressing changes in the reference voltage Vref caused by stress changes.

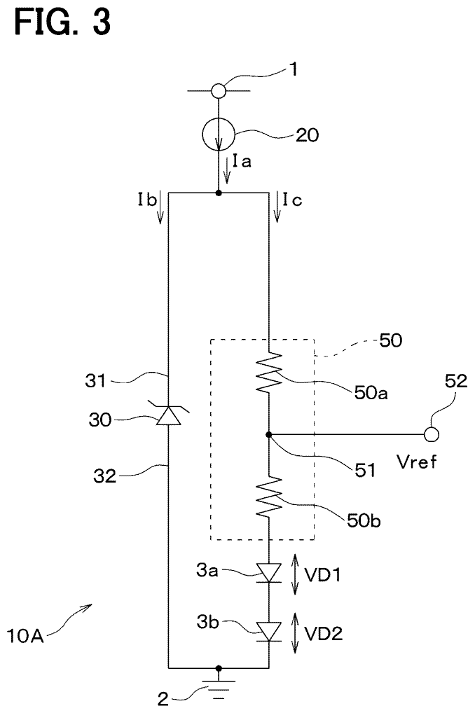

In contrast to this, FIG. 3 shows a comparative example, in which a reference voltage output circuit 10A has diodes 3a and 3b connected in series between the resistor divider circuit 50 and the negative electrode 2, The diode 3a has an anode terminal connected to the resistor element 50b, and a cathode terminal connected to the anode terminal of the diode 3b. The diode 3b has an anode terminal connected to the cathode terminal of the diode 3a, and a cathode terminal connected to the negative electrode 2. In this case, a branch current Ic flows from the current source 20 to the negative electrode 2 through the resistor elements 50a, 50b and the diodes 3a, 3b. At this time, a voltage VD1 resulting from the PN junction of the diode 3a is generated between the anode terminal and the cathode terminal of the diode 3a. A voltage VD2 resulting from the PN junction of diode 3b is generated between the anode terminal and the cathode terminal of the diode 3b. In the Zener diode 30, the Zener voltage generated between the cathode terminal 31 and the anode terminal 32 due to the Zener effect is denoted as VZ. The sum of the voltage VD1 and the voltage VD2 is defined as the voltage (VD1+VD2).

The resistor divider circuit 50 outputs the reference voltage Vref, which is the sum of a voltage obtained by multiplying the Zener voltage VZ by the first weight and a voltage obtained by multiplying the voltage (VD1+VD2) by the second weight, from the common connection terminal 51, as shown in Formula 3.

$$V ref = \frac{R 2}{R 1 + R 2} V Z + \frac{R 1}{R 1 + R 2} ( V D 1 + V D 2 ) \qquad Formula 3$$

The Zener voltage VZ has a positive temperature dependency in which the higher the temperature of the Zener diode 30, the larger the Zener voltage VZ becomes. The voltage VD1 between the anode terminal and the cathode terminal of the diode 3a has a negative temperature dependency in which the voltage VD1 decreases as the temperature of the diode 3a increases. The voltage VD2 between the anode terminal and the cathode terminal of the diode 3b has a negative temperature dependency in which the voltage VD2 decreases as the temperature of the diode 3b increases. Therefore, the temperature dependency of the Zener voltage is offset by the temperature dependency of the inter-terminal voltage of the diode 3a and the temperature dependency of the inter-terminal voltage of the diode 3b.

Therefore, the resistor divider circuit 50 can suppress the change in the reference voltage Vref caused by the temperature change. Furthermore, when the reference voltage output circuit 10A constitutes an integrated circuit device similar to the reference voltage output circuit 10A of the first embodiment, stress may be applied to the Zener diode 30 and the diodes 3a, 3b from the package components. In this case, the stress coefficient of the reference voltage Vref, which is obtained by partially differentiating the reference voltage Vref with respect to the stress, can be expressed by Formula 4.

$$\frac{\partial }{\partial σ} = V ref \frac{R 2}{R 1 + R 2} \frac{\partial }{\partial σ} V Z + \frac{R 1}{R 1 + R 2} \frac{\partial }{\partial σ} V D 1 + \frac{R 1}{R 1 + R 2} \frac{\partial }{\partial σ} V D 2 > 0 \qquad Formula 4$$

Here, tensile stress is represented by a positive value, and compressive stress is represented by a negative value. In Formula 4, the stress coefficient of the Zener voltage VZ is a positive value. In other words, when a tensile stress is applied to the Zener diode 30 from the package components, the Zener voltage VZ increases. When compressive stress is applied to the Zener diode 30 from the package components, the Zener voltage VZ decreases. The stress coefficient of the voltage VD1 obtained by partially differentiating the voltage VD1 with respect to the stress is a positive value. Therefore, when a tensile stress is applied to the diode 3a from the package components, the voltage VD1 increases, and when a compressive stress is applied to the diode 3a from the package components, the voltage VD1 decreases. The stress coefficient of the voltage VD2 obtained by partially differentiating the voltage VD2 with respect to the stress is a positive value. Therefore, when a tensile stress is applied to the diode 3b from the package component, the voltage VD2 increases, and when a compressive stress is applied to the diode 3b from the package component, the voltage VD2 decreases. Therefore, the stress coefficient of the reference voltage Vref is a positive value. Thus, the reference voltage Vref changes due to stress applied from the package components and the like.

In contrast, according to the reference voltage output circuit 10 of the present embodiment, the stress dependency of the voltage VA and the stress dependency of the voltage VB cancel each other out, and the stress dependency of the Zener voltage VZ is canceled out by the stress dependency of the voltage VA. Therefore, as described above, it is possible to suppress the change in the reference voltage Vref caused by the change in stress applied from the package components or the like. In this embodiment, the following effects (a), (b), and (c) can be obtained.

(a) The transistor 40 is diode-connected by having the base terminal 43 connected to the collector terminal 41. This allows the transistor 40 to generate the voltage VA resulting from the PN junction with a simple configuration.

(b) Similarly, the transistor 60 is diode-connected by having the base terminal 63 connected to the collector terminal 62. This allows the transistor 60 to generate the voltage VB due to the second PN junction with a simple configuration.

(c) The resistor divider circuit 50 has the resistor elements 50a, 50b connected in series between the transistor 40 and the transistor 60. In the resistor divider circuit 50, a voltage obtained by dividing the voltage (VZ−VA) using the resistor elements 50a, 50b corresponds to a voltage obtained by multiplying the voltage (VZ−VA) by a weight. Further, a voltage obtained by dividing the voltage VB by the resistor elements 50a, 50b corresponds to a voltage obtained by multiplying the voltage VB by a weight. Therefore, it is possible to easily obtain the voltage obtained by multiplying the voltage (VZ−VA) by the first weight and the voltage obtained by multiplying the voltage VB by the second weight.

### Second Embodiment

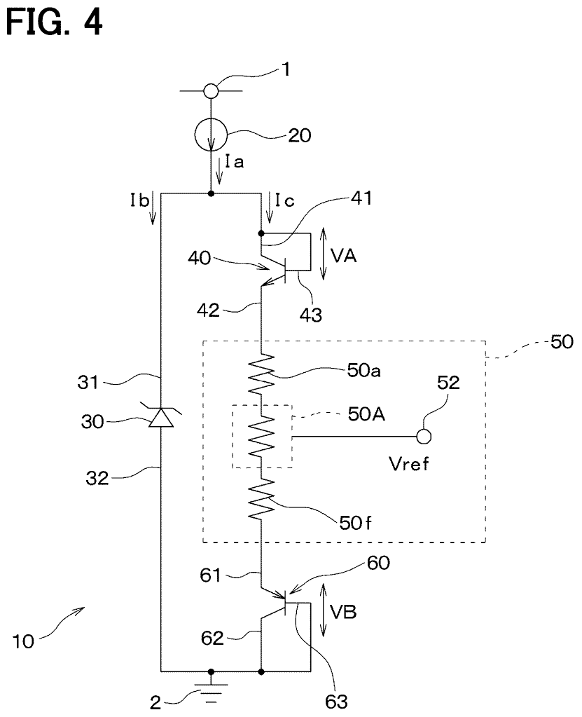

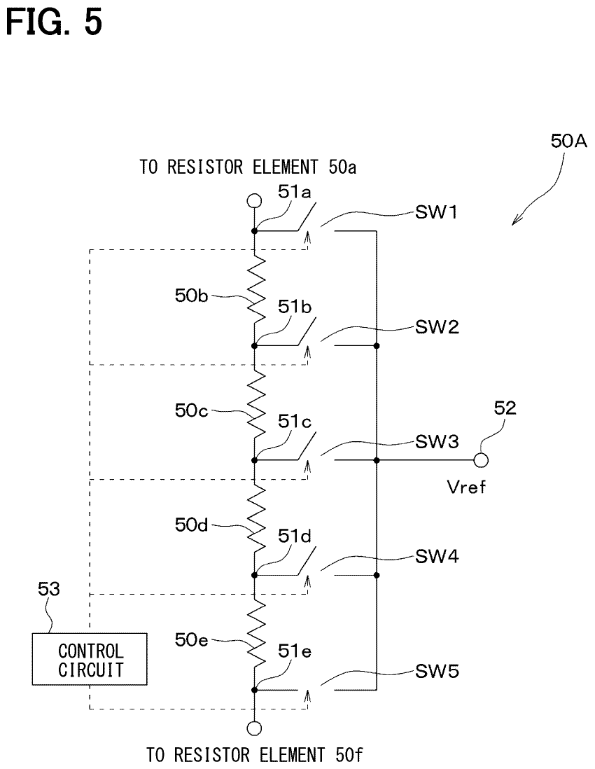

In the first embodiment, the reference voltage Vref is output from the common connection terminal 51 of the two resistor elements 50a, 50b in the resistor divider circuit 50. However, the reference voltage Vref is not limited to the above. In a second embodiment, which will be described with reference to FIGS. 4 and 5, a reference voltage Vref of an appropriate voltage value is output using three or more resistor elements. FIG. 4 is a circuit diagram showing the overall electric circuit configuration of the reference voltage output circuit 10. FIG. 5 is a circuit diagram showing the details of the electric circuit configuration of the resistor divider circuit 50 in FIG. 4. The reference voltage output circuit 10 of this embodiment differs from the reference voltage output circuit 10 of the first embodiment in the circuit configuration of the resistor divider circuit 50. The following mainly describes the resistor divider circuit 50 in the reference voltage output circuit 10 of this embodiment. In FIG. 4, the same reference numerals as those in FIG. 1 denote the same components, and the description thereof will be omitted.

As shown in FIG. 4, the resistor divider circuit 50 of this embodiment includes resistor elements 50a, 50f and a switch circuit 50A. The resistor elements 50a, 50f and the switch circuit 50A are connected in series between the transistor 40 and the transistor 60. The resistor element 50a is disposed between the transistor 40 and the switch circuit 50A. The switch circuit 50A is disposed between the resistor element 50a and the resistor element 50f. The resistor element 50f is disposed between the switch circuit 50A and the transistor 60.

As shown in FIG. 5, the switch circuit 50A includes the resistor elements 50b, 50c, 50d, 50e, the switches SW1, SW2, SW3, SW4, SW5, the output port 52, and a control circuit 53. The resistor elements 50b, 50c, 50d, 50e are connected in series between the resistor element 50a and the resistor element 50f. The resistor elements 50a, 50b, 50c, 50d, 50e, and 50f are arranged in this order from the transistor 40 to the transistor 60. For convenience of explanation, the resistor elements 50a, 50b, 50c, 50d, 50e, 50f may be collectively referred to as resistor elements 50a to 50f. The switches SW1, SW2, SW3, SW4, SW5 may be collectively referred to as switches SW1 to SW5.

Two of the resistor elements 50a to 50f adjacent to each other constitute a common connection terminal 51a, 51b, 51c, 51d, 51e at which the two adjacent resistor elements are commonly connected. Hereinafter, the common connection terminals 51a, 51b, 51c, 51d, 51e may be collectively referred to as common connection terminals 51a to 51e. The common connection terminal 51a is a terminal to which the resistor elements 50a and 50b are commonly connected. The common connection terminal 51b is a terminal to which the resistor elements 50b and 50c are commonly connected. The common connection terminal 51c is a terminal to which the resistor elements 50c and 50d are commonly connected. The common connection terminal 51d is a terminal to which the resistor elements 50d and 50e are commonly connected. The common connection terminal 51e is a terminal to which the resistor elements 50e and 50f are commonly connected.

The switch SW1 is disposed between the common connection terminal 51a and the output port 52. The switch SW1 connects or disconnects the common connection terminal 51a and the output port 52. The switch SW2 is disposed between the common connection terminal 51b and the output port 52. The switch SW2 connects or disconnects the common connection terminal 51b and the output port 52. The switch SW3 is disposed between the common connection terminal 51c and the output port 52. The switch SW3 connects or disconnects the common connection terminal 51c and the output port 52. The switch SW4 is disposed between the common connection terminal 51d and the output port 52. The switch SW4 connects or disconnects the common connection terminal 51d and the output port 52. The switch SW5 is disposed between the common connection terminal 51e and the output port 52. The switch SW5 connects or disconnects the common connection terminal 51e and the output port 52.

The output port 52 outputs the voltage between one of the common connection terminals 51a to 51e and the negative electrode 2 as a reference voltage Vref. The control circuit 53 turns on one of the switches SW1, SW2, SW3, SW4, SW5, and turns off the remaining four switches. As a result, the output voltage of any one of the common connection terminals 51a to 51e is output from the output port 52 as the reference voltage Vref. Next, the operation of the reference voltage output circuit 10 of this embodiment will be described with reference to FIGS. 4 and 5.

The current source 20 causes a main current Ia to flow from the positive electrode 1 to the negative electrode 2 based on the power supply voltage between the positive electrode 1 and the negative electrode 2. Of the main current Ia, a branch current Ib flows from the current source 20 through the Zener diode 30 to the negative electrode 2. As a result, in the Zener diode 30, a Zener voltage VZ is generated between the current source 20 and the negative electrode 2 due to the Zener effect. On the other hand, the branch current Ic of the main current Ia other than the branch current Ib flows through the transistor 40, the resistor elements 50a to 50f and the transistor 60 to the negative electrode 2.

The control circuit 53 turns on one of the switches SW1 to SW5 and turns off the remaining four switches. As a result, a connection is established between the common connection terminal corresponding to the one of the switches and the output port 52. Accordingly, the voltage between the negative electrode 2 and the common connection terminal corresponding to the one of the switches is output from the output port 52 as the reference voltage Vref.

For example, the control circuit 53 turns on the switch SW3 and turns off the switches SW1, SW2, SW4, SW5. The common connection terminal 51c is connected to the negative electrode 2, and the common connection terminals 51a, 51b, 51d, 51e is disconnected from the negative electrode 2. Therefore, the voltage between the common connection terminal 51c and the negative electrode 2 is output from the output port 52 as the reference voltage Vref. As shown in Formula 5, the resistor divider circuit 50 outputs the reference voltage Vref from the common connection terminal 51c, which is the sum of a voltage obtained by multiplying the voltage (VZ−VA) by a first weight and a voltage obtained by multiplying the voltage VB by a second weight. The voltage (VZ−VA) is obtained by stepping down the Zener voltage VZ by the voltage VA.

$$V ref = \frac{R 4 + R 5 + R 6}{R 1 + R 2 + R 3 + R 4 + R 5 + R 6} ( V Z - VA ) + \frac{R 1 + R 2 + R 3}{R 1 + R 2 + R 3 + R 4 + R 5 + R 6} V B \qquad Formula 5$$

The resistance value of the resistor element 50a is R1. The resistance value of the resistor element 50b is R2. The resistance value of the resistor element 50c is R3. The resistance value of the resistor element 50d is R4. The resistance value of the resistor element 50e is R5. The resistance value of the resistor element 50f is R6. Furthermore, in Formula 5, the first weight is a division value obtained by dividing R4+R5+R6, which is the sum of the resistance values of R4, R5 and R6, by R1+R2+R3+R4+R5+R6, which is the sum of the resistance values of R1, R2, R3, R4, R5, and R6.

The second weight is a division value obtained by dividing R1+R2+R3, which is the sum of the resistance values of R1, R2, and R3, by R1+R2+R3+R4+R5+R6. The reference voltage Vref is a sum of a divided voltage obtained by dividing the voltage (VZ−VA) by the resistor elements 50a, 50b, 50c, 50d, 50e, and 50f and a divided voltage obtained by dividing the voltage VB by the resistor elements 50a, 50b, 50c, 50d, 50e, and 50f. The stress coefficient of the reference voltage Vref can be expressed by the stress coefficient of the Zener voltage VZ, the stress coefficient of the voltage VA, and the stress coefficient of the voltage VB, as shown in Formula 6.

$$\frac{\partial }{\partial σ} V ref = \frac{R 4 + R 5 + R 6}{R 1 + R 2 + R 3 + R 4 + R 5 + R 6} ( \frac{\partial }{\partial σ} V Z - \frac{\partial }{\partial σ} VA ) + \frac{R 1 + R 2 + R 3}{R 1 + R 2 + R 3 + R 4 + R 5 + R 6} \frac{\partial }{\partial σ} V B ≅ 0 \qquad Formula 6$$

In this embodiment, similarly to the first embodiment, the transistors 40, 60 are set so that the stress coefficient of the voltage VA is greater than the stress coefficient of the voltage VB. The transistor 40 and the Zener diode 30 are set so that the stress coefficient of the voltage VA is greater than the stress coefficient of the Zener voltage VZ. Here, tensile stress is represented by a positive value, and compressive stress is represented by a negative value. In this case, the value obtained by subtracting the stress coefficient of the voltage VA from the stress coefficient of the Zener voltage VZ is a negative value. The stress coefficient of the voltage VB becomes a positive value. Therefore, the stress coefficient of the reference voltage Vref can be made close to zero, as shown in Formula 6.

In this embodiment, the resistor divider circuit 50 sets the voltage obtained by multiplying the voltage (VZ−VA) by the first weight and the voltage obtained by multiplying the voltage VB by the second weight as the reference voltage Vref. As a result, the temperature dependency of the Zener voltage VZ is offset by the temperature dependency of the voltage VA and the temperature dependency of the voltage VB. In addition, the stress dependency of the voltage VA and the stress dependency of the voltage VB are offset, and the stress dependency of the Zener voltage VZ is offset by the stress dependency of the voltage VA.

According to the present embodiment, the resistor divider circuit 50 includes the resistor elements 50a to 50f, the output port 52 that outputs the reference voltage Vref, and the switches SW1 to SW5. Two of the resistor elements 50a to 50f adjacent to each other constitute a common connection terminal 51a to 51f at which the two adjacent resistor elements are commonly connected. The switches SW1 to SW5 connect one of the common connection terminals 51a to 51f to the output port 52, and the remaining common connection terminals other than the one common connection terminal is disconnected from the output port 52.

As a result, the reference voltage output circuit 10 causes the output port 52 to output the voltage between the negative electrode 2 and any one of the common connection terminals 51a to 51f as the reference voltage Vref. Therefore, by outputting the output voltage of any one of the common connection terminals 51a to 51f from the output port 52 as the reference voltage Vref, it is possible to cause the output port 52 to output the reference voltage Vref of an appropriate voltage value.

### Third Embodiment

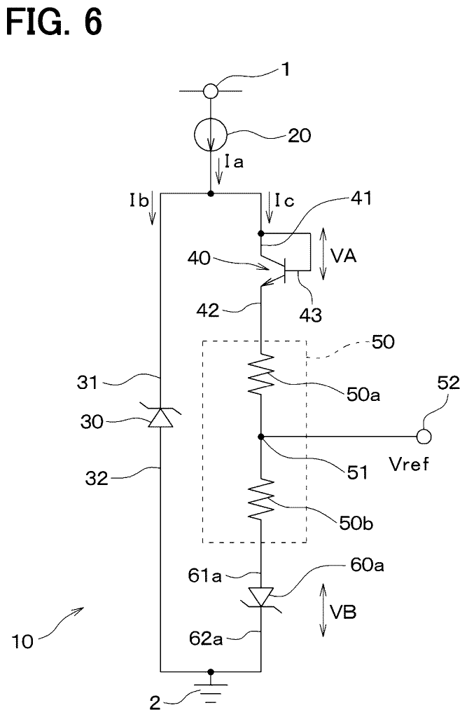

In the first embodiment, the transistor 60 is disposed as the second semiconductor portion between the resistor divider circuit 50 and the negative electrode 2 in the reference voltage output circuit 10. In a third embodiment, as shown in FIG. 6, a Zener diode 60a is disposed as a second semiconductor portion between the resistor divider circuit 50 and the negative electrode 2 in the reference voltage output circuit 10.

FIG. 6 is a circuit diagram showing the circuit configuration of the reference voltage output circuit 10 of the present embodiment. In FIG. 6, the same reference numerals as those in FIG. 1 denote the same components, and the description thereof will be omitted. The reference voltage output circuit 10 of this embodiment includes the Zener diode 60a in place of the transistor 60 as shown in FIG. 6. The Zener diode 60a has an anode terminal 61a as a second input terminal connected to the resistor divider circuit 50, and a cathode terminal 62a as a second output terminal connected to the negative electrode 2.

The Zener diode 60a is a second semiconductor portion including a P-type semiconductor and an N-type semiconductor. The P-type semiconductor is a second P-type semiconductor disposed between the resistor divider circuit 50 and the negative electrode 2. The anode terminal 61a is connected to the P-type semiconductor. The N-type semiconductor is a second N-type semiconductor disposed between the P-type semiconductor and the negative electrode 2. The N-type semiconductor is in contact with the P-type semiconductor to form a second PN junction. A cathode terminal is connected to the N-type semiconductor. The electric circuit configuration of the reference voltage output circuit 10 of this embodiment, other than the Zener diode 60a, is the same as that of the reference voltage output circuit 10 of the first embodiment.

The operation of the reference voltage output circuit 10 of this embodiment will be described with reference to FIG. 6. The current source 20 causes a main current Ia to flow from the positive electrode 1 to the negative electrode 2 based on the power supply voltage between the positive electrode 1 and the negative electrode 2. Further, a branch current Ib of the main current Ia flows from the current source 20 through the Zener diode 30 to the negative electrode 2. Accordingly, the Zener diode 30 generates a Zener voltage VZ between the current source 20 and the negative electrode 2 due to the Zener effect. On the other hand, a branch current Ic flows from the current source 20 to the negative electrode 2 through the transistor 40, the resistor elements 50a, 50b, and the Zener diode 60a.

Similar to the first embodiment, the branch current Ic flows from the collector terminal 41 of the transistor 40 through the first PN junction to the emitter terminal 42. Therefore, a voltage VA is generated between the collector terminal 41 and the emitter terminal 42 due to the first PN junction. A branch current Ic flows between the anode terminal 61a and the cathode terminal 62a through the second PN junction of the Zener diode 60a. As a result, a voltage VB due to the second PN junction is generated between the anode terminal 61a and the cathode terminal 62a.

The voltage VB has temperature dependency, which is negative, that is, the voltage VB decreases as the temperature of the Zener diode 60a increases, whereas the voltage VB increases as the temperature of the Zener diode 60a decreases. The voltage VB has a stress dependency, which is positive, that is, when a tensile stress is applied from the resin part 76 to the Zener diode 60a, the voltage VB increases, and when a compressive stress is applied from the resin part 76 to the Zener diode 60a, the voltage VB decreases. That is, the voltage VB in this embodiment has the same temperature dependency and stress dependency as the voltage VB in the first embodiment.

As in the first embodiment, the resistor divider circuit 50 outputs a reference voltage Vref from a common connection terminal 51, which is the sum of a voltage obtained by multiplying the voltage (VZ−VA) by a first weight and a voltage obtained by multiplying the voltage VB by a second weight. The voltage (VZ−VA) is obtained by stepping down the Zener voltage VZ by a voltage VA. As a result, the temperature dependency of the Zener voltage VZ is offset by the temperature dependency of the voltage VA and the temperature dependency of the voltage VB. In addition, the stress dependency of the voltage VA and the stress dependency of the voltage VB are offset, and the stress dependency of the Zener voltage VZ is offset by the stress dependency of the voltage VA.

According to the present embodiment, the reference voltage output circuit 10 includes the Zener diode 60a in place of the transistor 60 of the first embodiment. The Zener diode 60a has a P-type semiconductor disposed between the anode terminal 61a and the cathode terminal 62a. The Zener diode 60a has an N-type semiconductor provided between the P-type semiconductor and the cathode terminal 62a and in contact with the P-type semiconductor to form a second PN junction. The branch current Ic flows between the emitter terminal 61 and the collector terminal 62 of the transistor 60 via the second PN junction, so that a voltage VB due to the second PN junction is generated between the emitter terminal 61 and the collector terminal 62. The Zener diode 30, the transistor 40, and the Zener diode 60a are each covered with the resin part 76.

The Zener voltage VZ has the same temperature dependency and stress dependency as in the first embodiment. The voltage VA has the same temperature dependency and stress dependency as in the first embodiment. The voltage VB has the same temperature dependency and stress dependency as in the first embodiment. The resistor divider circuit 50 outputs, as the reference voltage Vref, a sum of the voltage obtained by multiplying the voltage (VZ−VA) by the first weight and the voltage obtained by multiplying the voltage VB by the second weight. As a result, the temperature dependency of the voltage VA and the temperature dependency of the voltage VB are offset, and the stress dependency of the Zener voltage VZ is offset by the stress dependency of the voltage VA. As a result, it is possible to provide the reference voltage output circuit 10 to suppress changes in the reference voltage Vref caused by temperature changes while suppressing changes in the reference voltage Vref caused by stress changes.

### Fourth Embodiment

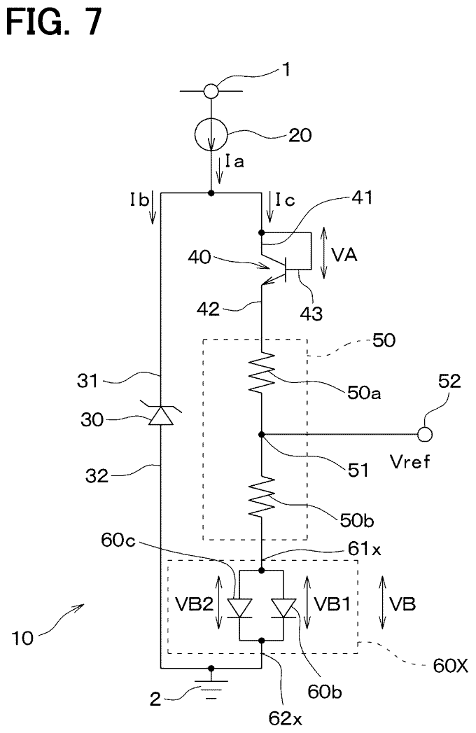

In the first embodiment, the transistor 60 is disposed between the resistor divider circuit 50 and the negative electrode 2 in the reference voltage output circuit 10. A fourth embodiment will be described with reference to FIG. 7, in which diodes 60b, 60c are arranged in parallel between the resistor divider circuit 50 and the negative electrode 2 in the reference voltage output circuit 10.

FIG. 7 is a circuit diagram showing the circuit configuration of the reference voltage output circuit 10 of the present embodiment. In FIG. 7, the same reference numerals as those in FIG. 1 denote the same components, and the description thereof will be omitted. The reference voltage output circuit 10 of this embodiment includes the diodes 60b, 60c instead of the transistor 60, as shown in FIG. 7. The diode 60b has an anode terminal serving as a second input terminal connected to the resistor divider circuit 50, and a cathode terminal serving as a second output terminal connected to the negative electrode 2. The diode 60c has an anode terminal serving as a second input terminal connected to the resistor divider circuit 50, and a cathode terminal serving as a second output terminal connected to the negative electrode 2.

The diodes 60b, 60c are semiconductor elements connected in parallel between the resistor divider circuit 50 and the negative electrode 2. The diodes 60b, 60c form a second semiconductor portion 60X. The anode terminal of the diode 60b and the anode terminal of the diode 60c are commonly connected to an input terminal 61x of the second semiconductor portion 60X. The cathode terminal of the diode 60b and the cathode terminal of the diode 60c are commonly connected to an output terminal 62x of the second semiconductor portion 60X.

The diode 60b includes a P-type semiconductor and an N-type semiconductor. The P-type semiconductor is disposed between the resistor divider circuit 50 and the negative electrode 2. An anode terminal is connected to the P-type semiconductor. The N-type semiconductor is disposed between the P-type semiconductor and the negative electrode 2. The N-type semiconductor is in contact with the P-type semiconductor to form a second PN junction. A cathode terminal is connected to the N-type semiconductor. The diode 60c includes a P-type semiconductor and an N-type semiconductor. The P-type semiconductor is disposed between the resistor divider circuit 50 and the negative electrode 2. An anode terminal is connected to the P-type semiconductor. The N-type semiconductor is disposed between the P-type semiconductor and the negative electrode 2. The N-type semiconductor is in contact with the P-type semiconductor to form a second PN junction. A cathode terminal is connected to the N-type semiconductor.

The P-type semiconductor of the diode 60b and the P-type semiconductor of the diode 60c each constitute a second P-type semiconductor. The N-type semiconductor of the diode 60b and the N-type semiconductor of the diode 60c each constitute a second N-type semiconductor. In the reference voltage output circuit 10 of this embodiment, the electric circuit configuration other than the diodes 60b, 60c is the same as that of the reference voltage output circuit 10 of the first embodiment. The operation of the reference voltage output circuit 10 of this embodiment will be described with reference to FIG. 7.

The current source 20 causes a main current Ia to flow from the positive electrode 1 to the negative electrode 2 based on the power supply voltage between the positive electrode 1 and the negative electrode 2. Of the main current Ia, a branch current Ib flows from the current source 20 through the Zener diode 30 to the negative electrode 2. Accordingly, the Zener diode 30 generates a Zener voltage VZ between the current source 20 and the negative electrode 2 due to the Zener effect. On the other hand, a branch current Ic flows from the current source 20 to the negative electrode 2 through the transistor 40, the resistor elements 50a, 50b, and the diodes 60b, 60c.

Specifically, a part of the branch current Ic flows through the diode 60b. The remaining current other than the branch current Ic flows through the diode 60c. That is, a current flows from the resistor divider circuit 50 to each of the diodes 60b, 60c. As a result, a voltage VB caused by the first PN junction and the second PN junction is generated between the input terminal 61x and the output terminal 62x of the second semiconductor portion 60X. In the reference voltage output circuit 10 of FIG. 7, the voltage generated between the anode terminal and the cathode terminal of the diode 60b, due to the second PN junction of the diode 60b, is designated as voltage VB1.

In the reference voltage output circuit 10 of FIG. 7, the voltage generated between the anode terminal and cathode terminal of the diode 60c, due to the second PN junction of the diode 60c, is designated as voltage VB2. In this embodiment, a current flows from the resistor divider circuit 50 to the diodes 60b, 60c according to the current-voltage characteristics of the second PN junction of the diodes 60b, 60c so that the voltages VB1 and VB2 become the same voltage VB.

The voltage VB1 has temperature dependency, which is negative, that is, when the temperature of the diode 60b rises, the voltage VB1 decreases, whereas when the temperature of the diode 60b drops, the voltage VB1 increases. The voltage VB2 has temperature dependency, which is negative, that is, when the temperature of the diode 60c rises, the voltage VB2 decreases, whereas when the temperature of the diode 60c drops, the voltage VB2 increases. Therefore, the voltage VB has a negative temperature dependency in which, when the temperature of the diodes 60b, 60c rises, the voltage VB decreases, whereas, when the temperature of the diodes 60b, 60c falls, the voltage VB increases. That is, the voltage VB in this embodiment has the same temperature dependency as the voltage VB in the first embodiment.

The voltage VB1 has stress dependency, which is positive, that is, when a tensile stress is applied from the resin part 76 to the diode 60b, the voltage VB1 increases, whereas when a compressive stress is applied from the resin part 76 to the diode 60b, the voltage VB1 decreases. The voltage VB2 has stress dependency, which is positive, that is, when a tensile stress is applied from the resin part 76 to the diode 60c, the voltage VB2 increases, whereas when a compressive stress is applied from the resin part 76 to the diode 60c, the voltage VB2 decreases. The voltage VB has a positive stress dependency in that when a tensile stress is applied from the resin part 76 to the diodes 60b, 60c, the voltage VB increases, whereas when a compressive stress is applied from the resin part 76 to the diodes 60b, 60c, the voltage VB decreases. That is, the voltage VB in this embodiment has the same stress dependency as the voltage VB in the first embodiment.

As in the first embodiment, the resistor divider circuit 50 of this embodiment outputs a reference voltage Vref from a common connection terminal 51, which is the sum of a voltage obtained by multiplying voltage (VZ−VA) by a first weight and a voltage obtained by multiplying voltage VB by a second weight. As a result, the temperature dependency of the Zener voltage VZ is offset by the temperature dependency of the voltage VA and the temperature dependency of the voltage VB. In addition, the stress dependency of the voltage VA and the stress dependency of the voltage VB are offset, and the stress dependency of the Zener voltage VZ is offset by the stress dependency of the voltage VA.

The reference voltage output circuit 10 of the present embodiment includes the diodes 60b, 60c in place of the transistor 60 of the first embodiment. The diodes 60b, 60c constitute the second semiconductor portion 60X, connected in parallel, between the resistor divider circuit 50 and the negative electrode 2. A voltage VB, which is the average of the voltages VB1 and VB2, is generated between the input terminal 61x and the output terminal 62x of the second semiconductor portion 60X.

The voltage VA in this embodiment has the same temperature dependency and stress dependency as the voltage VA in the first embodiment. In this embodiment, the voltage VB has a negative temperature dependency in that the voltage VB decreases as the temperature of the diodes 60b, 60c increases, whereas the voltage VB increases as the temperature of the diodes 60b, 60c decreases. The voltage VB has stress dependency such that when a tensile stress is applied from the resin part 76 to the diodes 60b, 60c, the voltage VB increases, whereas when a compressive stress is applied from the resin part 76 to the diodes 60b, 60c, the voltage VB decreases. In this embodiment, the resistor divider circuit 50 outputs a reference voltage Vref from the output port 52, which is the sum of a voltage obtained by multiplying the voltage (VZ−VA) by a first weight and a voltage obtained by multiplying the voltage VB by a second weight.

Therefore, similarly to the first embodiment, the temperature dependency of the Zener voltage VZ is offset by the temperature dependency of the voltage VA and the temperature dependency of the voltage VB. In addition, the stress dependency of voltage VA and the stress dependency of voltage VB are offset, and the stress dependency of Zener voltage VZ is offset by the stress dependency of voltage VA. As a result, it is possible to provide a reference voltage output circuit 10 that suppresses changes in the reference voltage caused by temperature changes and also suppresses changes in the reference voltage caused by stress changes.

### Fifth Embodiment

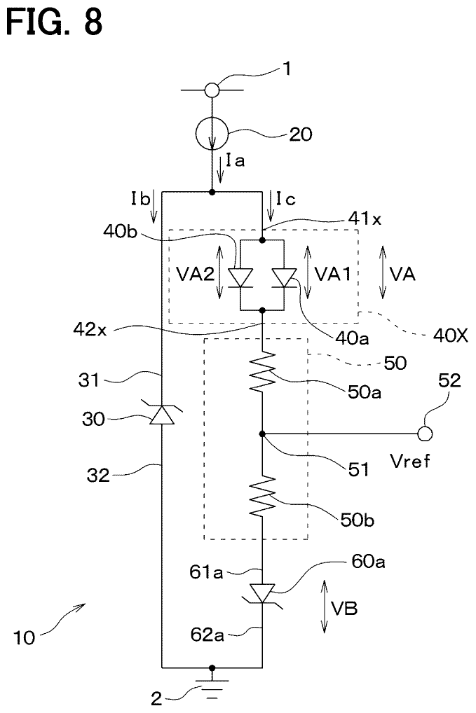

In the third embodiment, the transistor 40 is disposed between the current source 20 and the resistor divider circuit 50 in the reference voltage output circuit 10. A fifth embodiment will be described with reference to FIG. 8, in which diodes 40a, 40b are connected in parallel between the current source 20 and the resistor divider circuit 50 in the reference voltage output circuit 10. FIG. 8 is a circuit diagram showing the circuit configuration of the reference voltage output circuit 10 of the present embodiment. In FIG. 8, the same reference numerals as those in FIG. 6 denote the same components, and the description thereof will be omitted.

The reference voltage output circuit 10 of this embodiment includes the diodes 40a, 40b instead of the transistor 40, as shown in FIG. 8. The diode 40a has an anode terminal serving as a first input terminal connected to the current source 20, and a cathode terminal serving as a first output terminal connected to the resistor divider circuit 50. The diode 40b has an anode terminal serving as a first input terminal connected to the current source 20, and a cathode terminal serving as a first output terminal connected to the resistor divider circuit 50. The diodes 40a, 40b are semiconductor elements connected in parallel between the current source 20 and the negative electrode 2. The diodes 40a, 40b form a first semiconductor portion 40X.

The anode terminal of the diode 40a and the anode terminal of the diode 40b are commonly connected to an input terminal 41x of the first semiconductor portion 40X. The cathode terminal of the diode 40a and the cathode terminal of the diode 40b are commonly connected to an output terminal 42x of the first semiconductor portion 40X. The diode 40a includes a P-type semiconductor and an N-type semiconductor. The P-type semiconductor is disposed between the current source 20 and the resistor divider circuit 50. The anode terminal is connected to the P-type semiconductor. The N-type semiconductor is disposed between the P-type semiconductor and the resistor divider circuit 50. The N-type semiconductor is in contact with the P-type semiconductor to form a first PN junction. The cathode terminal is connected to the N-type semiconductor.

The diode 40b includes a P-type semiconductor and an N-type semiconductor. The P-type semiconductor is disposed between the current source 20 and the resistor divider circuit 50. An anode terminal is connected to the P-type semiconductor. The N-type semiconductor is disposed between the P-type semiconductor and the resistor divider circuit 50. The N-type semiconductor is in contact with the P-type semiconductor to form a first PN junction. The cathode terminal is connected to the N-type semiconductor. The P-type semiconductor of the diode 40a and the P-type semiconductor of the diode 40b each constitute a first P-type semiconductor. The N-type semiconductor of the diode 40a and the N-type semiconductor of the diode 40b each constitute a first N-type semiconductor. In the reference voltage output circuit 10 of this embodiment, the electric circuit configuration other than the diodes 40a, 40b is the same as that of the reference voltage output circuit 10 of the third embodiment.

Next, the operation of the reference voltage output circuit 10 of this embodiment will be described with reference to FIG. 8. The current source 20 causes a main current Ia to flow from the positive electrode 1 to the negative electrode 2 based on the power supply voltage between the positive electrode 1 and the negative electrode 2. A branch current Ib flows from the current source 20 through the Zener diode 30 to the negative electrode 2. As a result, in the Zener diode 30, a Zener voltage VZ is generated between the current source 20 and the negative electrode 2 due to the Zener effect. On the other hand, a branch current Ic flows from the current source 20 to the negative electrode 2 through the diodes 40a, 40b, the resistor elements 50a, 50b, and the diodes 60b, 60c. Specifically, a part of the branch current Ic flows through the diode 40a. The remaining current other than the branch current Ic flows through the diode 40b.

As a result, a voltage VA resulting from the first PN junction of the diodes 40a, 40b is generated between the input terminal 41x and the output terminal 42x of the first semiconductor portion 40X. In the reference voltage output circuit 10 of FIG. 8, the voltage generated between the anode terminal and the cathode terminal of the diode 40a due to the first PN junction of the diode 40a is designated as voltage VA1. In the reference voltage output circuit 10 of FIG. 8, the voltage generated between the anode terminal and the cathode terminal of the diode 40b due to the first PN junction of the diode 40b is designated as voltage VA2. In this embodiment, current flows from the current source 20 to the diodes 40a, 40b in accordance with the current-voltage characteristics of the first PN junction of the diodes 40a, 40b so that the voltages VA1 and VA2 are the same voltage VA.

The voltage VA1 has temperature dependency, which is negative, that is, when the temperature of the diode 40a rises, the voltage VA1 decreases, whereas when the temperature of the diode 40a drops, the voltage VA1 increases. The voltage VA2 has temperature dependency, which is negative, that is, when the temperature of the diode 40b rises, the voltage VA2 decreases, whereas when the temperature of the diode 40b drops, the voltage VA2 increases. The voltage VA has a negative temperature dependency in that, as the temperature of the diodes 40a, 40b increases, the voltage VA decreases, whereas, as the temperature of the diodes 40a, 40b decreases, the voltage VA increases. That is, the voltage VA in this embodiment has the same temperature dependency as the voltage VA in the first embodiment. The voltage VA1 has stress dependency, which is positive, that is, when a tensile stress is applied from the resin part 76 to the diode 40a, the voltage VA1 increases, whereas when a compressive stress is applied from the resin part 76 to the diode 40a, the voltage VA1 decreases. The voltage VA2 has stress dependency, which is positive, that is, when a tensile stress is applied from the resin part 76 to the diode 40b, the voltage VA2 increases, whereas when a compressive stress is applied from the resin part 76 to the diode 40b, the voltage VA2 decreases. The voltage VA has a positive stress dependency in that when a tensile stress is applied from the resin part 76 to the diodes 40a, 40b, the voltage VA increases, whereas when a compressive stress is applied from the resin part 76 to the diodes 40a, 40b, the voltage VA decreases. That is, the voltage VA in this embodiment has the same stress dependency as the voltage VA in the third embodiment.

Similar to the first embodiment, the resistor divider circuit 50 outputs the reference voltage Vref from the output port 52, which is a sum of a voltage obtained by multiplying the voltage (VZ−VA) by the first weight and a voltage obtained by multiplying the voltage VB by the second weight. As a result, the temperature dependency of the Zener voltage VZ is offset by the temperature dependency of the voltage VA and the temperature dependency of the voltage VB. In addition, the stress dependency of the voltage VA and the stress dependency of the voltage VB are offset, and the stress dependency of the Zener voltage VZ is offset by the stress dependency of the voltage VA.

The reference voltage output circuit 10 of the present embodiment includes the diodes 40a, 40b in place of the transistor 40 of the third embodiment. The diodes 40a, 40b constitute the first semiconductor portion 40X, connected in parallel, between the current source 20 and the resistor divider circuit 50. A voltage VA resulting from the first PN junction of the diodes 40a, 40b is generated between the input terminal 41x and the output terminal 42x of the first semiconductor portion 40X. The voltage VA has a negative temperature dependency in that, as the temperature of the diodes 40a, 40b increases, the voltage VA decreases, whereas, as the temperature of the diodes 40a, 40b decreases, the voltage VA increases. The voltage VA has a positive stress dependency in that when a tensile stress is applied from the resin part 76 to the diodes 40a, 40b, the voltage VA increases, whereas when a compressive stress is applied from the resin part 76 to the diodes 40a, 40b, the voltage VA decreases. The voltage VA in this embodiment has the same temperature dependency and stress dependency as the voltage VA in the third embodiment.

As in the third embodiment, the resistor divider circuit 50 of this embodiment outputs the reference voltage Vref from the output port 52, which is a sum of a voltage obtained by multiplying the voltage (VZ−VA) by the first weight and a voltage obtained by multiplying the voltage VB by the second weight. Therefore, similarly to the third embodiment, the temperature dependency of the Zener voltage VZ is offset by the temperature dependency of the voltage VA and the temperature dependency of the voltage VB. The stress dependency of the voltage VA and the stress dependency of the voltage VB are offset, and the stress dependency of the Zener voltage VZ is offset by the stress dependency of the voltage VA. As a result, it is possible to provide a reference voltage output circuit 10 that suppresses changes in the reference voltage caused by temperature changes and also suppresses changes in the reference voltage caused by stress changes.

### Sixth Embodiment

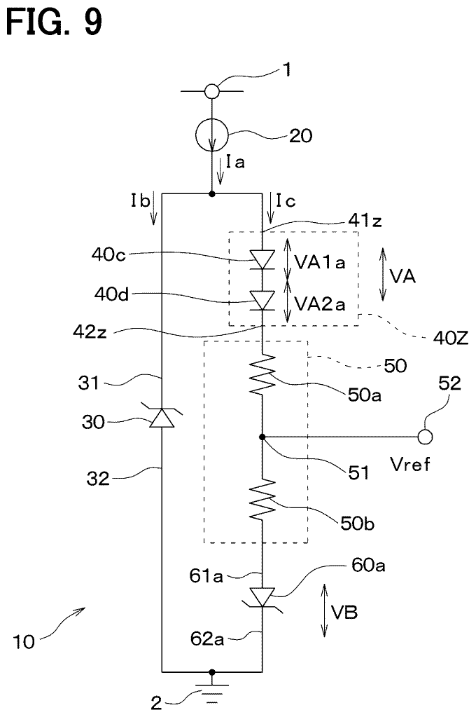

In the third embodiment, the transistor 40 is disposed between the current source 20 and the resistor divider circuit 50 in the reference voltage output circuit 10. A sixth embodiment will be described with reference to FIG. 9, in which diodes 40c, 40d are connected in series between the current source 20 and the resistor divider circuit 50, in the reference voltage output circuit 10. FIG. 9 is a circuit diagram showing the circuit configuration of the reference voltage output circuit 10 of the present embodiment. In FIG. 9, the same reference numerals as those in FIG. 6 denote the same components, and the description thereof will be omitted. The reference voltage output circuit 10 of this embodiment includes the diodes 40c, 40d in place of the transistor 40, as shown in FIG. 9.

The diode 40c has an anode terminal connected to the current source 20 and a cathode terminal connected to the anode terminal of diode 40d. The diode 40d has an anode terminal 41b connected to the cathode terminal of the diode 40c, and a cathode terminal connected to the resistor divider circuit 50. The diodes 40c, 40d are semiconductor elements connected in series between the current source 20 and the resistor divider circuit 50. The diodes 40c, 40d form a first semiconductor portion 40Z. The anode terminal of the diode 40c constitutes an input terminal 41z of the first semiconductor portion 40Z. The cathode terminal of the diode 40d constitutes an output terminal 42z of the first semiconductor portion 40X.

The diode 40c includes a P-type semiconductor and an N-type semiconductor. The P-type semiconductor is disposed between the current source 20 and the diode 40d. An anode terminal is connected to the P-type semiconductor. The N-type semiconductor is disposed between the P-type semiconductor and the diode 40d. The N-type semiconductor contacts the P-type semiconductor to form a first PN junction. A cathode terminal is connected to the N-type semiconductor. The diode 40d includes a P-type semiconductor and an N-type semiconductor. The P-type semiconductor is disposed between the diode 40c and the resistor divider circuit 50. An anode terminal is connected to the P-type semiconductor. The N-type semiconductor is disposed between the P-type semiconductor and the resistor divider circuit 50. Furthermore, the N-type semiconductor is in contact with the P-type semiconductor to form a first PN junction. A cathode terminal is connected to the N-type semiconductor. In the reference voltage output circuit 10 of this embodiment, the electric circuit configuration other than the diodes 40c, 40d is the same as that of the reference voltage output circuit 10 of the third embodiment.

Next, the operation of the reference voltage output circuit 10 of this embodiment will be described with reference to FIG. 9. First, the current source 20 causes a main current Ia to flow from the positive electrode 1 to the negative electrode 2 based on the power supply voltage between the positive electrode 1 and the negative electrode 2. A branch current Ib flows from the current source 20 through the Zener diode 30 to the negative electrode 2. As a result, in the Zener diode 30, a Zener voltage VZ is generated between the current source 20 and the negative electrode 2 due to the Zener effect. On the other hand, a branch current Ic flows from the current source 20 to the negative electrode 2 through the diodes 40c, 40d, the resistor elements 50a, 50b, and the Zener diode 60a.

At this time, a voltage VA1a resulting from the first PN junction of the diode 40c is generated between the anode terminal and the cathode terminal 42c of the diode 40c. A voltage VA2a resulting from the first PN junction of the diode 40d is generated between the anode terminal 41d and the cathode terminal of the diode 40d. In this embodiment, a voltage VA which is a sum of the voltages VA1a and VA2a is generated between the input terminal 41x and the output terminal 42x of the first semiconductor portion 40X.

The voltage VA1a has temperature dependency, which is negative, that is, when the temperature of the diode 40c rises, the voltage VA1a decreases, whereas when the temperature of the diode 40c drops, the voltage VA1a increases. The voltage VA2a has temperature dependency, which is negative, that is, when the temperature of the diode 40d rises, the voltage VA2a decreases, whereas when the temperature of the diode 40d drops, the voltage VA2a increases. The temperature dependency of the voltage VA is negative, that is, when the temperature of the diodes 40c, 40d rises, the voltage VA decreases, whereas when the temperature of the diodes 40c, 40d falls, the voltage VA increases. That is, the voltage VA in this embodiment has the same temperature dependency as the voltage VA in the first embodiment.

The voltage VA1a has stress dependency, which is positive, that is, when a tensile stress is applied from the resin part 76 to the diode 40c, the voltage VA1a increases, whereas when a compressive stress is applied from the resin part 76 to the diode 40c, the voltage VA1a decreases. The voltage VA2a has stress dependency, which is positive, that is, when a tensile stress is applied from the resin part 76 to the diode 40d, the voltage VA2a increases, whereas when a compressive stress is applied from the resin part 76 to the diode 40d, the voltage VA2a decreases. The voltage VA has a positive stress dependency in that when a tensile stress is applied from the resin part 76 to the diodes 40c, 40d, the voltage VA increases, whereas when a compressive stress is applied from the resin part 76 to the diodes 40c, 40d, the voltage VA decreases. That is, the voltage VA in this embodiment has the same stress dependency as the voltage VA in the first embodiment.

As in the third embodiment, the resistor divider circuit 50 of this embodiment outputs the reference voltage Vref from the common connection terminal 51, which is a sum of a voltage obtained by multiplying the voltage (VZ−VA) by a first weight and a voltage obtained by multiplying the voltage VB by a second weight. As a result, the temperature dependency of the Zener voltage VZ is offset by the temperature dependency of the voltage VA and the temperature dependency of the voltage VB. In addition, the stress dependency of the voltage VA and the stress dependency of the voltage VB are offset, and the stress dependency of the Zener voltage VZ is offset by the stress dependency of the voltage VA.

The reference voltage output circuit 10 of the present embodiment includes the diodes 40c, 40d in place of the transistor 40. The diode 40c has an anode terminal connected to the current source 20 and a cathode terminal connected to the diode 40d. The diode 40d has an anode terminal connected to the diode 40c and a cathode terminal connected to the resistor divider circuit 50. The diodes 40c, 40d are connected in series between the current source 20 and the resistor divider circuit 50 to form a first semiconductor portion 40Z. A voltage VA, which is the sum of the voltages VA1 and VA2, is generated between the input terminal 41z and the output terminal 42z of the first semiconductor portion 40Z.

The voltage VA has a negative temperature dependency in that, as the temperature of the diodes 40c, 40d increases, the voltage VA decreases, whereas, as the temperature of the diodes 40c, 40d decreases, the voltage VA increases. The voltage VA has a positive stress dependency in that when a tensile stress is applied from the resin part 76 to the diodes 40c and 40d, the voltage VA increases, whereas when a compressive stress is applied from the resin part 76 to the diodes 40c and 40d, the voltage VA decreases. The voltage VB in this embodiment has the same temperature dependency and stress dependency as the voltage VB in the third embodiment. As in the third embodiment, the resistor divider circuit 50 of this embodiment outputs the reference voltage Vref from the output port 52, which is a sum of a voltage obtained by multiplying the voltage (VZ−VA) by the first weight and a voltage obtained by multiplying the voltage VB by the second weight.

Therefore, similarly to the third embodiment, the temperature dependency of the Zener voltage VZ is offset by the temperature dependency of the voltage VA and the temperature dependency of the voltage VB. The stress dependency of the voltage VA and the stress dependency of the voltage VB are offset, and the stress dependency of the Zener voltage VZ is offset by the stress dependency of the voltage VA. As a result, it is possible to provide a reference voltage output circuit 10 that suppresses changes in the reference voltage caused by temperature changes and also suppresses changes in the reference voltage caused by stress changes.

### Seventh Embodiment

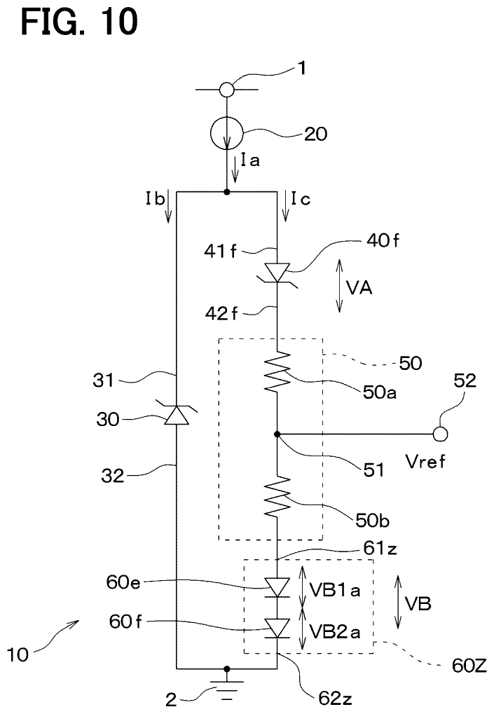

In the fourth embodiment, the diodes 60b, 60c are connected in parallel between the resistor divider circuit 50 and the negative electrode 2 in the reference voltage output circuit 10. A seventh embodiment will be described with reference to FIG. 10, in which diodes 60e, 60f are connected in series between the resistor divider circuit 50 and the negative electrode 2, in the reference voltage output circuit 10.

FIG. 10 is a circuit diagram showing the circuit configuration of the reference voltage output circuit 10 of the present embodiment. In FIG. 10, the same reference numerals as those in FIG. 7 denote the same components, and the description thereof will be omitted. As shown in FIG. 10, the reference voltage output circuit 10 of this embodiment includes the diodes 60e, 60f instead of the diodes 60b, 60c. The diodes 60e, 60f are semiconductor elements connected in series between the resistor divider circuit 50 and the negative electrode 2. The diodes 60e, 60f form a second semiconductor portion 60Z.

The diode 60e has an anode terminal connected to the resistor divider circuit 50 and a cathode terminal connected to the anode terminal of the diode 60f. The anode terminal of the diode 60e constitutes an input terminal 61z of the second semiconductor portion 60Z. The diode 60f has an anode terminal connected to the cathode terminal of the diode 60e, and a cathode terminal connected to the negative electrode 2. The cathode terminal of the diode 60f constitutes an output terminal 62z of the second semiconductor portion 60Z.

As shown in FIG. 10, the diode 60e includes a P-type semiconductor and an N-type semiconductor. The P-type semiconductor is disposed between the resistor divider circuit 50 and the diode 60f. An anode terminal is connected to the P-type semiconductor. The N-type semiconductor is disposed between the P-type semiconductor and the negative electrode 2. The N-type semiconductor is in contact with the P-type semiconductor to form a second PN junction. A cathode terminal is connected to the N-type semiconductor. The diode 60f includes a P-type semiconductor and an N-type semiconductor. The P-type semiconductor is disposed between the diode 60e and the negative electrode 2. An anode terminal is connected to the P-type semiconductor. The N-type semiconductor is disposed between the P-type semiconductor and the negative electrode 2. The N-type semiconductor is in contact with the P-type semiconductor to form a second PN junction. A cathode terminal is connected to the N-type semiconductor. The P-type semiconductor of the diode 60f and the P-type semiconductor of the diode 60e each constitute a second P-type semiconductor. The N-type semiconductor of the diode 60f and the N-type semiconductor of the diode 60e each constitute a second N-type semiconductor.

As shown in FIG. 10, the reference voltage output circuit 10 of this embodiment includes a Zener diode 40f instead of the transistor 40. The Zener diode 40f has an anode terminal 41f as a first input terminal connected to the current source 20, and a cathode terminal 42f as a first output terminal connected to the resistor divider circuit 50. The Zener diode 40f includes a P-type semiconductor and an N-type semiconductor. The P-type semiconductor is a first P-type semiconductor disposed between the resistor divider circuit 50 and the negative electrode 2. An anode terminal 41f is connected to the P-type semiconductor. The N-type semiconductor is disposed between the P-type semiconductor and the negative electrode 2. The N-type semiconductor is in contact with the P-type semiconductor to form a first PN junction. The N-type semiconductor is a first N-type semiconductor to which the cathode terminal 42f is connected. In the reference voltage output circuit 10 of this embodiment, the electric circuit configuration other than the Zener diode 40f and the diodes 60e, 60f is the same as that of the reference voltage output circuit 10 of the fourth embodiment.

Next, the operation of the reference voltage output circuit 10 of this embodiment will be described with reference to FIG. 10. First, the current source 20 causes a main current Ia to flow from the positive electrode 1 to the negative electrode 2 based on the power supply voltage between the positive electrode 1 and the negative electrode 2. As a result, a branch current Ib flows from the current source 20 through the Zener diode 30 to the negative electrode 2. Therefore, the Zener diode 30 generates a Zener voltage VZ between the current source 20 and the negative electrode 2 due to the Zener effect. On the other hand, a branch current Ic flows from the current source 20 to the negative electrode 2 through the Zener diode 40f, the resistor elements 50a, 50b, and the diodes 60e, 60f.

A voltage VA due to the first PN junction is generated between the anode terminal 41f and the cathode terminal 42f of the Zener diode 40f. A voltage VB1a resulting from the second PN junction of the diode 60e is generated between the anode terminal and the cathode terminal of the diode 60e. A voltage VB2a resulting from the second PN junction of the diode 60f is generated between the anode terminal and the cathode terminal of the diode 60f. As a result, a voltage VB, which is the sum of the voltages VB1a and VB2a, is generated between the input terminal 61z and the output terminal 62z of the second semiconductor portion 60Z.

The voltage VA has temperature dependency, which is negative, that is, the voltage VA decreases as the temperature of the Zener diode 40f increases, whereas the voltage VA increases as the temperature of the Zener diode 40f decreases. That is, the voltage VA in this embodiment has the same temperature dependency as the voltage VA in the fourth embodiment. The voltage VA has a stress dependency, which is positive, that is, when a tensile stress is applied from the resin part 76 to the Zener diode 40f, the voltage VA increases, whereas when a compressive stress is applied from the resin part 76 to the Zener diode 40f, the voltage VA decreases. That is, the voltage VA in this embodiment has the same stress dependency as the voltage VA in the fourth embodiment.

The voltage VB1a has temperature dependency, which is negative, that is, when the temperature of the diode 60e increases, the voltage VB1a decreases, whereas when the temperature of the diode 60e decreases, the voltage VB1a increases. The voltage VB2a has temperature dependency, which is negative, that is, when the temperature of the diode 60f rises, the voltage VB2a decreases, whereas when the temperature of the diode 60f drops, the voltage VB2a increases. Therefore, the voltage VB has a negative temperature dependency in that, when the temperature of the diodes 60e, 60f increases, the voltage VB decreases, whereas, when the temperature of the diodes 60e, 60f decreases, the voltage VB increases. That is, the voltage VB in this embodiment has the same temperature dependency as the voltage VB in the fourth embodiment.

The voltage VB1a has stress dependency, which is positive, that is, when a tensile stress is applied from the resin part 76 to the diode 60e, the voltage VB1a increases, whereas when a compressive stress is applied from the resin part 76 to the diode 60e, the voltage VB1a decreases. The voltage VB2a has stress dependency, which is positive, that is, when a tensile stress is applied from the resin part 76 to the diode 60f, the voltage VB2a increases, whereas when a compressive stress is applied from the resin part 76 to the diode 60f, the voltage VB2a decreases. Therefore, the voltage VB has stress dependency such that when a tensile stress is applied from the resin part 76 to the diodes 60e, 60f, the voltage VB increases, whereas when a compressive stress is applied from the resin part 76 to the diodes 60e, 60f, the voltage VB decreases. That is, the voltage VB in this embodiment has the same stress dependency as the voltage VB in the fourth embodiment.

As in the fourth embodiment, the resistor divider circuit 50 of this embodiment outputs a reference voltage Vref from the common connection terminal 51, which is a sum of a voltage obtained by multiplying the voltage (VZ−VA) by a first weight and a voltage obtained by multiplying the voltage VB by a second weight. As a result, the temperature dependency of the Zener voltage VZ is offset by the temperature dependency of the voltage VA and the temperature dependency of the voltage VB. In addition, the stress dependency of the voltage VA and the stress dependency of the voltage VB are offset, and the stress dependency of the Zener voltage VZ is offset by the stress dependency of the voltage VA.

The reference voltage output circuit 10 of the present embodiment includes the Zener diode 40f in place of the transistor 40. The Zener diode 40f has an anode terminal 41f connected to the current source 20 and a cathode terminal 42f connected to the resistor divider circuit 50. A voltage VA resulting from the first PN junction of the Zener diode 40f is generated between the anode terminal 41d and the cathode terminal 42f of the Zener diode 40f. The voltage VA has a negative temperature dependency in that, as the temperature of the Zener diode 40f increases, the voltage VA decreases, whereas, as the temperature of the Zener diode 40f decreases, the voltage VA increases. The voltage VA has a positive stress dependency in that the voltage VA increases when a tensile stress is applied from the resin part 76 to the Zener diode 40f, whereas the voltage VA decreases when a compressive stress is applied from the resin part 76 to the Zener diode 40f.

The reference voltage output circuit 10 includes the diodes 60e, 60f in place of the diodes 60b, 60c. The diode 60e has an anode terminal connected to resistor divider circuit 50 and a cathode terminal connected to the anode terminal of diode 60f. The diode 60f has an anode terminal connected to the cathode terminal of the diode 60e, and a cathode terminal connected to the negative electrode 2. The diodes 60e, 60f are connected in series between the resistor divider circuit 50 and the negative electrode 2 to form a second semiconductor portion 60Z. A voltage VB, which is the sum of the voltages VB1a and VB2a, is generated between the input terminal 61z and the output terminal 62z of the second semiconductor portion 60Z.

The voltage VB has a negative temperature dependency in that, as the temperature of the diodes 60e, 60f increases, the voltage VB decreases, whereas, as the temperature of the diodes 60e, 60f decreases, the voltage VB increases. The voltage VB has a positive stress dependency in that when a tensile stress is applied from the resin part 76 to the diodes 60e, 60f, the voltage VB increases, whereas when a compressive stress is applied from the resin part 76 to the diodes 60e, 60f, the voltage VB decreases. As in the fourth embodiment, the resistor divider circuit 50 of this embodiment outputs from the output port 52 the reference voltage Vref, which is a sum of a voltage obtained by multiplying the voltage (VZ−VA) by the first weight and a voltage obtained by multiplying the voltage VB by the second weight.

Therefore, similarly to the fourth embodiment, the temperature dependency of the Zener voltage VZ is offset by the temperature dependency of the voltage VA and the temperature dependency of the voltage VB. The stress dependency of the voltage VA and the stress dependency of the voltage VB are offset, and the stress dependency of the Zener voltage VZ is offset by the stress dependency of the voltage VA. As a result, it is possible to provide a reference voltage output circuit 10 that suppresses changes in the reference voltage caused by temperature changes and also suppresses changes in the reference voltage caused by stress changes.

### Eighth Embodiment

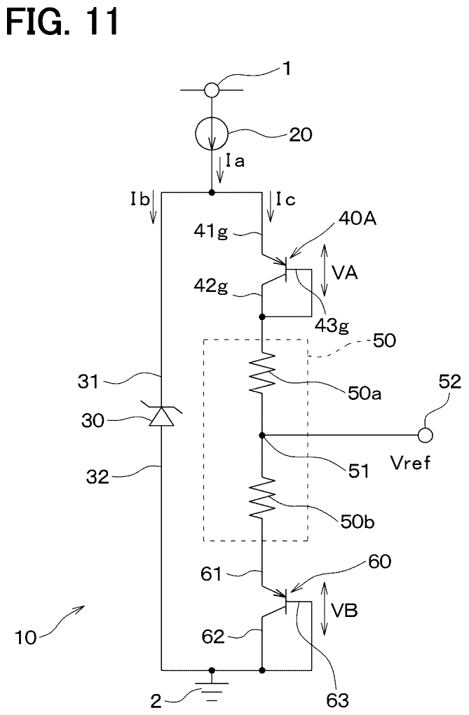

In the first embodiment, an NPN-type transistor is used as the transistor 40 disposed between the current source 20 and the resistor divider circuit 50 in the reference voltage output circuit 10. In an eighth embodiment, as shown in FIG. 11, a PNP transistor 40A is disposed between the current source 20 and the resistor divider circuit 50 in the reference voltage output circuit 10.

FIG. 11 is a circuit diagram showing the circuit configuration of the reference voltage output circuit 10 of the present embodiment. In FIG. 11, the same reference numerals as those in FIG. 1 denote the same components, and the description thereof will be omitted. As shown in FIG. 11, the reference voltage output circuit 10 of this embodiment includes a transistor 40A instead of the transistor 40 as a first semiconductor portion. The transistor 40A comprises a P-type semiconductor arranged between the current source 20 and the resistor divider circuit 50, an N-type semiconductor arranged between the P-type semiconductor and the resistor divider circuit 50, and a P-type semiconductor arranged between the N-type semiconductor and the resistor divider circuit 50.

For the sake of convenience, the two P-type semiconductors of the transistor 40A will be described below in order to distinguish them from one another. The P-type semiconductor arranged between the current source 20 and the N-type semiconductor is a positive-side P-type semiconductor, and the P-type semiconductor arranged between the N-type semiconductor and the resistor divider circuit 50 is a negative-side P-type semiconductor. An emitter terminal 41g is connected to the positive-side P-type semiconductor. A base terminal 43g is connected to the N-type semiconductor. The positive-side P-type semiconductor is a first P-type semiconductor that is in contact with the N-type semiconductor to form a first PN junction. The negative-side P-type semiconductor is connected to a collector terminal 42g. The configuration of the reference voltage output circuit 10 of this embodiment, other than the transistor 40A, is similar to that of the reference voltage output circuit 10 of the first embodiment. Next, the operation of the reference voltage output circuit 10 of this embodiment will be described with reference to FIGS. 1. 2 and 3.

The current source 20 causes a main current Ia to flow from the positive electrode 1 to the negative electrode 2 based on the power supply voltage between the positive electrode 1 and the negative electrode 2. A branch current Ib, which is a part of the main current Ia, flows from the current source 20 through the Zener diode 30 to the negative electrode 2. Accordingly, the Zener diode 30 generates a Zener voltage VZ between the current source 20 and the negative electrode 2 due to the Zener effect. On the other hand, a branch current Ic other than the branch current Ib of the main current Ia flows from the current source 20 to the negative electrode 2 through the transistors 40A, 60 and the resistor elements 50a, 50b.

A branch current Ic flows from the emitter terminal 41g of the transistor 40A through the first PN junction to the N-type semiconductor. A base current, which is a portion of the branch current Ic, flows from the N-type semiconductor to the base terminal 43g, bypassing the negative-side P-type semiconductor, and to the collector terminal 42g. This causes the transistor 40A to turn on. Accordingly, in the transistor 40A, the remaining current of the branch current Ic other than the base current flows to the collector terminal 42g through the N-type semiconductor and the negative P-type semiconductor. Therefore, a branch current Ic flows from the collector terminal 41 through the first PN junction to the emitter terminal 42. Therefore, a voltage VA due to the first PN junction is generated between the collector terminal (i.e., the first input terminal) 41 and the emitter terminal 42 (i.e., the second output terminal).

Moreover, the branch current Ic flows through the transistor 60, similarly to the first embodiment. Therefore, a branch current Ic flows from the emitter terminal 61 through the second P-type semiconductor and the collector terminal 62 to the negative electrode 2. Therefore, a voltage VB, which is a second voltage caused by the second PN junction, is generated between the emitter terminal 61 and the collector terminal 62. Furthermore, as shown in Formula 1, the resistor divider circuit 50 outputs a reference voltage Vref from the common connection terminal 51a, which is a sum of a voltage obtained by multiplying a voltage (VZ−VA), which is obtained by stepping down the Zener voltage VZ by a voltage VA, by a first weight, and a voltage obtained by multiplying the voltage VB by a second weight.

The Zener voltage VZ has the same temperature dependency as in the first embodiment. The voltage VA, similar to that in the first embodiment, has temperature dependency. Therefore, the voltage (VZ−VA) has a positive temperature dependency. The voltage VB has the same temperature dependency as in the first embodiment. The Zener voltage VZ has the same stress dependency as in the first embodiment. The voltage VA has the same stress dependency as in the first embodiment. The voltage VB has the same stress dependency as in the first embodiment. As shown in Formula 2, the stress coefficient of the reference voltage Vref can be expressed by the stress coefficient of the Zener voltage VZ, the stress coefficient of the voltage VA, and the stress coefficient of the voltage VB.

Furthermore, in this embodiment, the resistor divider circuit 50 sets the sum of the voltage obtained by multiplying the voltage (VZ−VA) by the first weight and the voltage obtained by multiplying the voltage VB by the second weight to the reference voltage Vref. This causes the stress dependency of the voltage VA and the stress dependency of the voltage VB to cancel each other out. In this embodiment, by using a PNP transistor as the transistor 40A, the stress coefficient of the voltage VA in this embodiment is smaller than the stress coefficient of the voltage VA in the first embodiment.

According to the present embodiment, the reference voltage output circuit 10 includes the current source 20, the Zener diode 30, the transistors 40A, 60, and the resistor divider circuit 50. The transistor 40A, 60 is a PNP type transistor. The resistor divider circuit 50 outputs, as the reference voltage Vref, a sum of a voltage obtained by multiplying the voltage (VZ−VA) by the first weight and a voltage obtained by multiplying the voltage VB by the second weight. As a result, the temperature dependency of the Zener voltage VZ is offset by the temperature dependency of the voltage VA and the temperature dependency of the voltage VB. In addition, the stress dependency of the voltage VA and the stress dependency of the voltage VB are cancelled out. Therefore, the reference voltage output circuit 10 can suppress changes in the reference voltage Vref caused by changes in stress, compared to the reference voltage output circuit 10A of FIG. 3. As a result, it is possible to provide a reference voltage output circuit 10 that suppresses changes in the reference voltage Vref caused by temperature changes while suppressing changes in the reference voltage Vref caused by stress changes.

(1) In the first embodiment, the first semiconductor portion is formed by one transistor 40. However, the first semiconductor portion may be formed of two or more transistors 40. Similarly, the second semiconductor portion is not limited to being formed by one transistor 60, and may be formed by two or more transistors 60.

(2) In the second embodiment, the resistor divider circuit 50 is configured using six resistor elements 50a to 50f. However, if three or more resistor elements are used, the number of resistor elements constituting the resistor divider circuit 50 is not limited to six.

(3) In the third embodiment, the second semiconductor portion is formed of one Zener diode 60a. However, the second semiconductor portion may be configured by two or more Zener diodes 60a.

(4) In the fourth embodiment, the second semiconductor portion is configured by two diodes 60b, 60c connected in parallel. However, the second semiconductor portion may be configured by three or more diodes connected in parallel. Similarly, the second semiconductor portion may be formed of plural Zener diodes connected in parallel. Similarly, the second semiconductor portion may be formed of plural transistors connected in parallel. Furthermore, the second semiconductor portion may be configured by combining plural semiconductor elements connected in parallel with plural semiconductor elements connected in series. Here, the semiconductor element refers to any one of a BJT, a diode, and a Zener diode.

(5) In the fifth embodiment, the first semiconductor portion is formed of two diodes 40a, 40b connected in parallel. However, the first semiconductor portion may be configured by three or more diodes connected in parallel. Similarly, the first semiconductor portion may be formed of plural Zener diodes connected in parallel. Similarly, the first semiconductor portion may be formed of plural transistors connected in parallel. Furthermore, the first semiconductor portion may be configured by combining plural semiconductor elements connected in parallel with plural semiconductor elements connected in series. Here, the semiconductor element refers to any one of a BJT, a diode, and a Zener diode.

(6) In the sixth embodiment, the first semiconductor portion is configured by two diodes 40c, 40d connected in series. However, the first semiconductor portion may be configured by three or more diodes connected in series. Similarly, the first semiconductor portion may be formed of plural Zener diodes connected in series. Similarly, the first semiconductor portion may be formed of plural transistors connected in series.

(7) In the seventh embodiment, the second semiconductor portion is configured by two diodes 60e, 60f connected in series. However, the second semiconductor portion may be configured by three or more diodes connected in series. Similarly, the second semiconductor portion may be formed of plural Zener diodes connected in series. Similarly, the second semiconductor portion may be formed of plural transistors connected in series.

(8) In the first embodiment, a Zener voltage is generated between the current source 20 and the negative electrode 2 by one Zener diode 30 disposed between the current source 20 and the negative electrode 2. However, two or more Zener diodes 30 may be disposed between the current source 20 and the negative electrode 2 to generate a Zener voltage between the current source 20 and the negative electrode 2. Similarly, in the second to seventh embodiments, two or more Zener diodes 30 may be disposed between the current source 20 and the negative electrode 2 to generate a Zener voltage between the current source 20 and the negative electrode 2.

(9) In the first embodiment, the resin part 76 made of an electrically insulating resin material is used. However, the resin part 76 may be made of ceramics. Similarly, in the second to seventh embodiments, the resin part 76 may be made of ceramics. Furthermore, in the first to seventh embodiments, the resin part 76 may be made of a material other than resin material and ceramics.

(10) The present disclosure is not limited to the above-described embodiments and may be suitably modified. In addition, the embodiments described above are not unrelated to each other, and may be appropriately combined unless the combination is obviously impossible. Further, in each of the above-mentioned embodiments, it goes without saying that components of the embodiment are not necessarily essential except for a case in which the components are particularly clearly specified as essential components, a case in which the components are clearly considered in principle as essential components, and the like. Further, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. Further, in each of the embodiments described above, when referring to the shape, positional relationship, and the like of the components and the like, the shape and relationship are not limited to the shape, positional relationship, and the like, except for the case where the shape and the positional relationship are specifically specified, the case where the shape and the positional relationship are fundamentally limited to a specific shape, positional relationship, and the like.

What is claimed is:

1. A reference voltage output circuit comprising:
a current source disposed between a positive electrode and a negative electrode of a DC power supply, to supply a main current, which is a constant DC current, from the positive electrode to the negative electrode based on a power supply voltage between the positive electrode and the negative electrode;
a Zener diode disposed between the current source and the negative electrode, to generate a Zener voltage between the current source and the negative electrode due to Zener effect when a first branch current, which is a part of the main current, flows through the Zener diode;
a first semiconductor portion having
a first input terminal disposed between the current source and the negative electrode,
a first output terminal disposed between the first input terminal and the negative electrode,
a first P-type semiconductor disposed between the first input terminal and the first output terminal, and
a first N-type semiconductor disposed between the first P-type semiconductor and the first output terminal and in contact with the first P-type semiconductor to form a first PN junction, wherein a second branch current of the main current excluding the first branch current flows from the first input terminal through the first PN junction to the first output terminal, thereby generating a first voltage due to the first PN junction between the first input terminal and the first output terminal;
a second semiconductor portion having
a second input terminal disposed between the first semiconductor portion and the negative electrode,
a second output terminal disposed between the second input terminal and the negative electrode,
a second P-type semiconductor disposed between the second input terminal and the second output terminal, and
a second N-type semiconductor disposed between the second P-type semiconductor and the second output terminal and in contact with the second P-type semiconductor to form a second PN junction, wherein the second branch current flows from the second input terminal through the second PN junction to the second output terminal, thereby generating a second voltage due to the second PN junction between the second input terminal and the second output terminal; and
a reference voltage generator disposed between the first semiconductor portion and the second semiconductor portion, to output a reference voltage, wherein the Zener diode, the first semiconductor portion, and the second semiconductor portion are covered by a package component,
the Zener voltage has temperature dependency in which the Zener voltage changes with a change in temperature of the Zener diode,
the first voltage has temperature dependency in which the first voltage changes with a change in temperature of the first semiconductor portion and stress dependency in which the first voltage changes due to stress applied from the package component to the first semiconductor portion,
the second voltage has temperature dependency in which the second voltage changes with a change in temperature of the second semiconductor portion and stress dependency in which the second voltage changes due to stress applied from the package component to the second semiconductor portion,
a voltage dropped from the Zener voltage by the first voltage is defined as a third voltage, and
the reference voltage generator outputs, as the reference voltage, a sum of a voltage obtained by multiplying the third voltage by a first weight and a voltage obtained by multiplying the second voltage by a second weight, so as to cancel out the temperature dependency of the Zener voltage by the temperature dependency of the first voltage and the temperature dependency of the second voltage, while canceling out the stress dependency of the first voltage and the stress dependency of the second voltage.

2. A reference voltage output circuit comprising:
a current source disposed between a positive electrode and a negative electrode of a DC power supply, to supply a main current, which is a constant DC current, from the positive electrode to the negative electrode based on a power supply voltage between the positive electrode and the negative electrode;
a Zener diode disposed between the current source and the negative electrode, to generate a Zener voltage between the current source and the negative electrode due to Zener effect when a first branch current, which is a part of the main current, flows through the Zener diode;
a first semiconductor portion having
a first input terminal disposed between the current source and the negative electrode,
a first output terminal disposed between the first input terminal and the negative electrode,
a first P-type semiconductor disposed between the first input terminal and the first output terminal, and
a first N-type semiconductor disposed between the first P-type semiconductor and the first output terminal and in contact with the first P-type semiconductor to form a first PN junction, wherein a second branch current of the main current excluding the first branch current flows from the first input terminal through the first PN junction to the first output terminal, thereby generating a first voltage due to the first PN junction between the first input terminal and the first output terminal;
a second semiconductor portion having
a second input terminal disposed between the first semiconductor portion and the negative electrode,
a second output terminal disposed between the second input terminal and the negative electrode,
a second P-type semiconductor disposed between the second input terminal and the second output terminal, and
a second N-type semiconductor disposed between the second P-type semiconductor and the second output terminal and in contact with the second P-type semiconductor to form a second PN junction, wherein the second branch current flows from the second input terminal through the second PN junction to the second output terminal, thereby generating a second voltage due to the second PN junction between the second input terminal and the second output terminal; and
a reference voltage generator disposed between the first semiconductor portion and the second semiconductor portion, to output a reference voltage, wherein
the Zener diode, the first semiconductor portion, and the second semiconductor portion are covered by a package component,
the Zener voltage has temperature dependency in which the Zener voltage changes with a change in temperature of the Zener diode and stress dependency in which the Zener voltage changes due to stress applied from the package component to the Zener diode,
the first voltage has temperature dependency in which the first voltage changes with a change in temperature of the first semiconductor portion and stress dependency in which the first voltage changes due to stress applied from the package component to the first semiconductor portion,
the second voltage has temperature dependency in which the second voltage changes with a change in temperature of the second semiconductor portion and stress dependency in which the second voltage changes due to stress applied from the package component to the second semiconductor portion,
a voltage dropped from the Zener voltage by the first voltage is defined as a third voltage, and
the reference voltage generator outputs, as the reference voltage, a sum of a voltage obtained by multiplying the third voltage by a first weight and a voltage obtained by multiplying the second voltage by a second weight, so as to cancel out the temperature dependency of the Zener voltage by the temperature dependency of the first voltage and the temperature dependency of the second voltage, while canceling out the stress dependency of the first voltage and the stress dependency of the second voltage, and canceling out the stress dependency of the Zener voltage by the stress dependency of the first voltage.

3. The reference voltage output circuit according to claim 1, wherein the first semiconductor portion includes any one of a bipolar junction transistor, a diode, and a Zener diode, as a semiconductor element.

4. The reference voltage output circuit according to claim 3, wherein the first semiconductor portion includes a plurality of semiconductor elements connected in series between the current source and the reference voltage generator.

5. The reference voltage output circuit according to claim 3, wherein the first semiconductor portion includes a plurality of semiconductor elements connected in parallel between the current source and the reference voltage generator.

6. The reference voltage output circuit according to claim 3, wherein the bipolar junction transistor has a base terminal connected to a collector terminal serving as the first input terminal in a diode-connection.

7. The reference voltage output circuit according to claim 3, wherein the first input terminal of the diode is an anode terminal, and the first output terminal of the diode is a cathode terminal.

8. The reference voltage output circuit according to claim 3, wherein the first input terminal of the Zener diode is an anode terminal, and the first output terminal of the Zener diode is a cathode terminal.

9. The reference voltage output circuit according to claim 1, wherein the second semiconductor portion includes any one of a bipolar junction transistor, a diode, and a Zener diode.

10. The reference voltage output circuit according to claim 9, wherein the second semiconductor portion includes a plurality of semiconductor elements connected in series between the reference voltage generator and the negative electrode.

11. The reference voltage output circuit according to claim 9, wherein the second semiconductor portion includes a plurality of semiconductor elements connected in parallel between the reference voltage generator and the negative electrode.

12. The reference voltage output circuit according to claim 9, wherein the bipolar junction transistor has a base terminal connected to a collector terminal serving as the second input terminal, in a diode-connection.

13. The reference voltage output circuit according to claim 9, wherein the second input terminal of the diode is an anode terminal, and the second output terminal of the diode is a cathode terminal.

14. The reference voltage output circuit according to claim 9, wherein the second input terminal of the Zener diode is an anode terminal, and the second output terminal of the Zener diode is a cathode terminal.

15. The reference voltage output circuit according to claim 1, wherein
the reference voltage generator has a plurality of resistor elements connected in series between the first semiconductor portion and the second semiconductor portion, and
in the reference voltage generator, the voltage obtained by multiplying the third voltage by the first weight is provided by dividing the third voltage by the plurality of resistor elements, and the voltage obtained by multiplying the second voltage by the second weight is provided by dividing the second voltage by the plurality of resistor elements.

16. The reference voltage output circuit according to claim 15, wherein
two of the plurality of resistor elements adjacent to each other has a common connection terminal at which the two adjacent resistor elements are commonly connected,
the reference voltage generator includes: an output port to output the reference voltage; and a plurality of switches to connect or disconnect the common connection terminal to or from the output port, and
the output port outputs, as the reference voltage, a voltage between the common connection terminal and the negative electrode by connecting the common connection terminal to the output port by a corresponding one of the plurality of switches.
